(19) United States
(12) Patent Application Publication
(10) Pub. No.: US 2023/0393324 A1
(43) Pub. Date: Dec. 7, 2023

(54) IMAGE DISPLAY DEVICE AND IMAGE DISPLAY METHOD

(71) Applicant: SONY GROUP CORPORATION, TOKYO (JP)

(72) Inventor: DAISUKE UEDA, TOKYO (JP)

(21) Appl. No.: 18/250,176

(22) PCT Filed: Sep. 15, 2021
(86) PCT No.: PCT/JP2021/033909

§ 371 Date: Apr. 21, 2023

(30) Foreign Application Priority Data
Nov. 6, 2020 (JP) 2020-185945

(51) Int. Cl. F21V 8/00; G02B 27/01; G02B 27/09; G02B 27/00; G02B 26/08

(52) U.S. Cl. CPC G02B 6/0035; G02B 27/0172; G02B 27/0955; G02B 6/0031; G02B 27/0983; G02B 27/0093; G02B 26/0816; G02B 2027/0123

(57) ABSTRACT

The purpose of the present invention is to provide an image display device capable of displaying an image at a wide angle of view while minimizing crosstalk. An image display device (10-1) according to the present invention includes an image formation system (100-1) configured to form an image from light, a light guide system (300-1), an incident optical system (200-1) configured to cause a plurality of rays of light forming different angles of view of the image to impinge on the light guide system (300-1), and a light diffraction system (400-1) configured to diffract the plurality of rays of light guided by the light guide system (300-1) to cause the plurality of rays of light to impinge on an eyeball in different directions. The light diffraction system (400-1) has incident angle selectivity for at least one of incident angles at which the plurality of rays of light guided by the light guide system (300-1) impinges on the light diffraction system (400-1).

### TECHNICAL FIELD

The technology according to the present disclosure (hereinafter, referred to as “the present technology”) relates to an image display device and an image display method.

### BACKGROUND ART

In the related art, there has been known a virtual image display device that allows an observer to visually recognize a virtual image (image) by causing rays of light constituting the virtual image to impinge on a position of an eye of the observer (see, for example, Patent Document 1).

### CITATION LIST

### Patent Document

Patent Document 1: Japanese Patent Application Laid-Open No. 2018-54978

### SUMMARY OF THE INVENTION

### Problems to be Solved by the Invention

The technology in the related art, however, has room for improvement in displaying an image at a wide angle of view while minimizing crosstalk.

It is therefore a main object of the present technology to provide a display device capable of displaying an image at a wide angle of view while minimizing crosstalk.

### Solutions to Problems

An image display device according to the present technology includes

an image formation system configured to form an image from light,

a light guide system,

an incident optical system configured to cause a plurality of rays of light forming different angles of view of the image to impinge on the light guide system, and

a light diffraction system configured to diffract the plurality of rays of light guided by the light guide system to cause the plurality of rays of light to impinge on an eyeball in different directions, in which

the light diffraction system has incident angle selectivity for at least one of incident angles at which the plurality of rays of light guided by the light guide system impinges on the light diffraction system.

At least two of the incident angles of the plurality of rays of light may be different from each other.

The light diffraction system may include a plurality of diffraction parts having incident angle selectivity for at least one of the at least two incident angles.

At least two of the plurality of diffraction parts may have incident angle selectivity for different incident angles of the at least two incident angles.

At least two of the plurality of diffraction parts may have incident angle selectivity for an identical incident angle of the at least two incident angles.

The light guide system may include a light guide plate, and at least two rays of light that each impinge on the light diffraction system at a corresponding one of the at least two incident angles may be at least two rays of light that have propagated while totally reflecting at mutually different total reflection angles in the light guide plate.

The at least two rays of light that each impinge on the light diffraction system at a corresponding one of the at least two incident angles may be at least two rays of light that have caused to impinge on the light guide plate at mutually different incident angles by the incident optical system.

The incident optical system may convert the plurality of rays of light forming different angles of view of the image into approximately parallel rays of light and cause the plurality of rays of light to impinge on the light guide plate.

Each of the plurality of diffraction parts may be provided at a position that coincides with a common multiple of a propagation distance in the light guide plate of a corresponding one of the at least two rays of light that each impinge on the light diffraction system at a corresponding one of the at least two incident angles.

The common multiple may be a least common multiple.

½ of a total reflection cycle of a ray of light having a longest total reflection cycle of the at least two rays of light that each impinge on the light diffraction system at a corresponding one of the at least two incident angles may coincide with an integral multiple of a total reflection cycle of a ray of light other than the ray of light having the longest total reflection cycle of the at least two rays of light.

Each of the plurality of diffraction parts may be provided at at least a position where a ray of light that impinges on the light diffraction system at a corresponding one of the incident angles impinges on a surface, adjacent to the eyeball, of the light guide plate or at at least a position where a ray of light that impinges on the light diffraction system at a corresponding one of the incident angles impinges on a surface, remote from the eyeball, of the light guide plate.

The light diffraction system may diffract a part of each of the plurality of rays of light guided by the light guide system toward a plurality of different positions adjacent to the eyeball.

The light diffraction system may include a diffraction part group including at least two of the diffraction parts that sequentially diffract different parts of each of at least two rays of light that each impinge on the light diffraction system at a corresponding one of the at least two incident angles toward a plurality of different positions adjacent to the eyeball.

The plurality of diffraction parts may include the diffraction part having at least two diffraction structures laminated in a thickness direction of the light guide plate, and the at least two diffraction structures may each have incident angle selectivity for the at least two incident angles.

The plurality of diffraction parts may include the diffraction part in which at least two diffraction patterns are provided, and the at least two diffraction patterns may each have incident angle selectivity for the at least two incident angles.

At least two rays of light that each impinge on the light diffraction system at a corresponding one of the at least two incident angles may be identical in wavelength to each other.

The image formation system may further include a chromatic aberration correction diffraction part configured to correct chromatic aberration in the light diffraction system.

The incident optical system may include a correction member configured to correct a difference in optical path length between the at least two rays of light that each impinge on the light diffraction system at a corresponding one of the at least two incident angles, the optical path length being from a position of incidence on the light guide plate to a corresponding one of the diffraction parts.

An optical member may be provided on a side of the light guide plate opposite from a position where the plurality of rays of light impinges on the light guide plate relative to a position where the light diffraction system is provided, and of the at least two rays of light that each impinge on the light diffraction system at a corresponding one of the at least two incident angles, a ray of light other than a ray of light having a longest optical path length from the position of incidence on the light guide plate to a corresponding one of the diffraction parts may be diffracted by the corresponding one of the diffraction parts after an optical path is folded back by the optical member.

The optical member may be disposed at a position where the difference in optical path length between the at least two rays of light that each impinge on the light diffraction system at a corresponding one of the at least two incident angles is smaller.

The image formation system may include a light source, a light deflector configured to deflect a ray of light emitted from the light source, an optical element disposed on an optical path between the light source and the light deflector, and a drive unit capable of moving the optical element in an optical axis direction of the optical element.

The image display device may further include a line-of-sight detection system configured to detect a line-of-sight that is an orientation of the eyeball, and a control system configured to control the drive unit on the basis of a detection result of the line-of-sight detection system and/or an image display position.

The image display device may further include a control system configured to control the drive unit on the basis of an image display position.

The image display device may further include a drive system capable of changing a position and/or an orientation of the image formation system.

The image display device may further include a line-of-sight detection system configured to detect a line-of-sight that is an orientation of the eyeball, and a control system configured to control the drive system on the basis of a detection result of the line-of-sight detection system and/or an image display position.

The image display device may further include a control system configured to control the drive system on the basis of an image display position.

The incident optical system may include a collimating lens configured to convert the plurality of rays of light forming different angles of view of the image into approximately parallel rays of light, and a mirror configured to reflect the plurality of rays of light converted into approximately parallel rays of light by the collimating lens in different directions for each space region to cause the plurality of rays of light to impinge on the light guide plate at different incident angles.

The incident optical system may include a mirror, and an optical system configured to cause the plurality of rays of light forming different angles of view of the image to impinge on the mirror at different angles for each angle of view region, and the mirror may reflect the plurality of incident rays of light toward the light guide plate.

An image display method according to the present technology includes

forming an image from light,

causing a plurality of rays of light forming different angles of view of the image to impinge on a light guide system,

guiding, by the light guide system, the plurality of rays of light, and

causing the plurality of rays of light guided in the guiding to impinge on an eyeball in different directions by diffracting, by a light diffraction system, the plurality of rays of light, in which

the light diffraction system has incident angle selectivity for at least one of incident angles at which the plurality of rays of light guided by the light guide system impinges on the light diffraction system.

In the image display method, at least two of the incident angles of the plurality of rays of light may be different from each other.

In the image display method, the light diffraction system may have incident angle selectivity for at least one incident angle of the at least two incident angles, and in the causing the plurality of rays of light to impinge, a ray of light incident on the light diffraction system at the at least one incident angle of the plurality of rays of light may be selectively diffracted by the light diffraction system.

### BRIEF DESCRIPTION OF DRAWINGS

FIG. 1 is a diagram illustrating a configuration of an image display device according to a first embodiment of the present technology.

FIG. 2 is a diagram for describing an arrangement of diffraction parts in the image display device according to the first embodiment of the present technology.

FIG. 3 is a flowchart for describing image display processing.

FIG. 4 is a diagram for describing an image display method according to the present technology.

FIGS. 5A and 5B are diagrams for describing image display methods according to comparative examples 1, 2, respectively.

FIG. 6 is a diagram illustrating a configuration of an image display device according to a second embodiment of the present technology.

FIG. 7 is a diagram illustrating a configuration of an image display device according to a third embodiment of the present technology.

FIG. 8 is a diagram illustrating a configuration of an image display device according to a fourth embodiment of the present technology.

FIG. 9 is a diagram illustrating a configuration of an image display device according to a fifth embodiment of the present technology.

FIG. 10 is a block diagram illustrating a function of the image display device according to the fifth embodiment of the present technology.

FIG. 11 is a diagram illustrating an operation example (part 1) of the image display device according to the fifth embodiment of the present technology.

FIG. 12 is a diagram illustrating an operation example (part 2) of the image display device according to the fifth embodiment of the present technology.

FIG. 13 is a diagram illustrating a configuration of an image display device according to a sixth embodiment of the present technology.

FIG. 14 is a block diagram illustrating a function of the image display device according to the sixth embodiment of the present technology.

FIG. 15 is a diagram illustrating an operation example (part 1) of the image display device according to the sixth embodiment of the present technology.

FIG. 16 is a diagram illustrating an operation example (part 2) of the image display device according to the sixth embodiment of the present technology.

FIG. 17 is a diagram illustrating a configuration of an image display device according to a seventh embodiment of the present technology.

FIG. 18 is a diagram illustrating an action example (part 1) of the image display device according to the seventh embodiment of the present technology.

FIG. 19 is a diagram illustrating an action example (part 2) of the image display device according to the seventh embodiment of the present technology.

FIG. 20 is a diagram illustrating a configuration of an image display device according to a first modification of the present technology.

FIG. 21 is a diagram illustrating a configuration of an image display device according to a second modification of the present technology.

FIG. 22 is a diagram illustrating a configuration of an image display device according to a third modification of the present technology.

FIG. 23 is a diagram illustrating a configuration of an image display device according to a fourth modification of the present technology.

FIG. 24 is a diagram illustrating a configuration of an image display device according to a fifth modification of the present technology.

FIG. 25 is a diagram illustrating a configuration of an image display device according to a sixth modification of the present technology.

FIG. 26 is a diagram illustrating a configuration of an image display device according to a seventh modification of the present technology.

FIG. 27 is a diagram illustrating a configuration of an image display device according to an eighth modification of the present technology.

### MODE FOR CARRYING OUT THE INVENTION

Hereinafter, preferred embodiments of the present technology will be described in detail with reference to the accompanying drawings. Note that, in the present specification and drawings, components having substantially the same functional configuration are denoted by the same reference numerals to avoid the description from being redundant. The embodiments to be described below are each a representative embodiment of the present technology, and the scope of the present technology is not restrictively interpreted by the embodiments. Herein, even in a case where it is described that an image display device and an image display method according to the present technology exhibit a plurality of effects, the image display device and the image display method according to the present technology are only required to exhibit at least one effect. Note that the effects described herein are merely examples and should not be restrictively interpreted, and other effects may be provided.

Furthermore, the description will be given in the following order.

1. Configuration of image display device according to first embodiment of present technology

2. Image display processing

3. Effect produced by image display device according to first embodiment of present technology

4. Image display device according to second embodiment of present technology

5. Image display device according to third embodiment of present technology

6. Image display device according to fourth embodiment of present technology

7. Image display device according to fifth embodiment of present technology

8. Image display device according to sixth embodiment of present technology

9. Image display device according to seventh embodiment of present technology

10. Modification of present technology

1. <Configuration of Image Display Device According to First Embodiment of Present Technology>

An image display device 10-1 according to a first embodiment of the present technology will be described with reference to the drawings.

As an example, the image display device 10-1 is a display device that directly renders an image on a retina by retina direct rendering using light, and is used for providing, to a user, augmented reality (AR), virtual reality (VR), or the like. Hereinafter, for the sake of convenience, the description will be given on the assumption that a left side of each drawing is a left side, a right side of each drawing is a right side, a front side of each drawing is an upper side, and a back side of each drawing is a lower side.

[Configuration of Image Display Device According to First Embodiment]

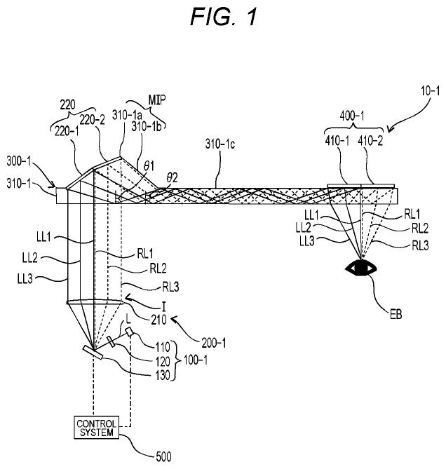

FIG. 1 is a diagram illustrating a configuration of the image display device 10-1 according to the first embodiment.

The image display device 10-1 functions as, for example, a head mounted display (HMD) used with being attached to a head of a user. The HMD is also called eyewear, for example.

The image display device 10-1 includes an image formation system 100-1, an incident optical system 200-1, a light guide system 300-1, and a light diffraction system 400-1.

The image display device 10-1 may further include a control system 500.

The image formation system 100-1, the incident optical system 200-1, the light guide system 300-1, and the light diffraction system 400-1 are integrally provided in the same support structure (for example, a spectacle frame).

The control system 500 may be provided integrally in or separately from the support structure.

Hereinafter, a description will be given on the assumption that the spectacle frame as an example of the support structure is attached to the head of the user.

(Image Formation System)

The image formation system 100-1 forms an image I from light L.

The image formation system 100-1 includes a light source 110, an optical element 120, and a light deflector 130.

The light source 110 is preferably a laser light source. Examples of the laser light source include semiconductor lasers such as an edge emitting laser (LD) and a surface emitting laser (VCSEL).

The light source 110 is driven by a light source drive circuit. The light source drive circuit drives the light source 110 on the basis of modulation data (to be described later) transmitted from the control system 500. That is, the light source 110 is controlled by the control system 500.

As an example, the light source 110 emits light of a single wavelength.

Examples of the optical element 120 include a condensing lens, a condensing mirror, and the like. The optical element 120 concentrates the light L emitted from the light source 110 on the light deflector 130. Note that the optical element 120 is not essential and may be omitted.

The light deflector 130 includes a movable mirror movable about two axes orthogonal to each other (for example, one axis perpendicular to FIG. 1 and the other axis orthogonal to the one axis), such as a MEMS mirror, a galvanometer mirror, or a polygon mirror. Note that the light deflector 130 may include a first movable mirror movable about the one axis and a second movable mirror movable about the other axis orthogonal to the one axis.

The light deflector 130 is controlled by the control system 500. The control system 500 controls the light deflector 130 in synchronization with the control of the light source 110.

(Light Guide System)

The light guide system 300-1 forms different angles of view of the image I and guides a plurality of rays of light (for example, LL1, LL2, LL3, RL1, RL2, RL3 (hereinafter, denoted as LL1 to RL3 as needed)) passing through the incident optical system 200-1. Here, only six rays of light LL1 to RL3 are each representatively illustrated as a ray of light for each angle of view of the image I from the viewpoint of preventing the drawing from being complicated.

The light guide system 300-1 includes a light guide plate 310-1 as an example.

The light guide plate 310-1 is, for example, a transparent, translucent, or opaque glass plate. The light guide plate 310-1 may be of a type (spectacle lens type) fitted into the spectacle frame as the support structure, or may be of a type (combiner type) externally attached to the spectacle frame.

In a case where augmented reality (AR) is provided to the user, a transparent or translucent glass plate is used as the light guide plate 310-1, for example. In a case where virtual reality (VR) is provided to the user, an opaque glass plate is used as the light guide plate 310-1, for example.

The light guide plate 310-1 includes a flat plate part 310-1c on the right side of a mirror installation part MIP to be described later. The flat plate part 310-1c has a pair of flat surfaces parallel to each other on both sides in a thickness direction. For example, the light guide plate 310-1 is disposed such that a flat surface on one side in the thickness direction of the flat plate part 310-1c faces an eyeball EB.

As an example, the mirror installation part MIP in which a composite mirror 220 to be described later is installed is provided in the vicinity of the left end of the surface, remote from the eyeball EB, of the light guide plate 310-1. The mirror installation part MIP includes, for example, an opening 310-1a and an inclined surface 310-1b. The inclined surface 310-1b is inclined so as to make its right end closer to the eyeball EB and is continuous with the flat surface, remote from the eyeball EB, of the flat plate part 310-1c, for example.

The surface, adjacent to the eyeball EB, of the light guide plate 310-1 is entirely a flat surface.

As an example, the flat plate part 310-1c preferably has a thickness of 2 mm to 5 mm, more preferably 2.5 mm to 4.5 mm, and still more preferably 3 mm to 4 mm. Here, the thickness of the flat plate part 310-1c is set at, for example, 3.1 mm.

(Incident Optical System)

The incident optical system 200-1 causes the plurality of rays of light (for example, LL1 to RL3) forming different angles of view of the image I formed by the image formation system 100-1 to impinge on the light guide system 300-1.

As an example, the incident optical system 200-1 converts the plurality of rays of light (for example, LL1 to RL3) forming different angles of view of the image I into approximately parallel rays of light and causes the plurality of rays of light to impinge on the light guide plate 310-1.

The incident optical system 200-1 includes collimating lens 210 and the composite mirror 220.

The collimating lens 210 converts the plurality of rays of light (for example, LL1 to RL3) forming different angles of view of the image I formed by the image formation system 100-1 into approximately parallel rays of light. That is, the collimating lens 210 converts angle of view information of the image I into space information.

As an example, the collimating lens 210 is disposed on an optical path of rays of light emitted from the light source 110 and deflected by the light deflector 130 after passing through the optical element 120 so as to make its optical axis orthogonal to the surface, adjacent to the eyeball EB, of the light guide plate 310-1.

As an example, the collimating lens 210 and the composite mirror 220 are provided such that a left end of the surface, adjacent to the eyeball EB, of the light guide plate 310-1 is interposed between the collimating lens 210 and the composite mirror 220.

More specifically, the collimating lens 210 is disposed on a side adjacent to the eyeball EB relative to the left end of the surface, adjacent to the eyeball EB, of the light guide plate 310-1, and the composite mirror 220 is disposed on a side remote from the eyeball EB relative to the left end of the surface, adjacent to the eyeball EB, of the light guide plate 310-1.

The composite mirror 220 reflects the plurality of rays of light converted into approximately parallel rays of light by the collimating lens 210 in different directions for each space region corresponding to an angle of view region to cause the plurality of rays of light to impinge on the light guide plate 310-1 at different incident angles.

The composite mirror 220 is provided integrally with the light guide plate 310-1, for example. The composite mirror 220 is provided around the opening 310-1a of the mirror installation part MIP so as to close the opening 310-1a. That is, the light guide plate 310-1 and the composite mirror 220 define an internal space of the light guide plate 310-1.

The composite mirror 220 integrally includes first and second reflectors 220-1, 220-2. Note that the first and second reflectors 220-1, 220-2 may be separate from each other on condition that the first and second reflectors 220-1, 220-2 are adjacent to each other with no gap.

Each reflector is, for example, a plane mirror.

The first reflector 220-1 is disposed on an optical path of a plurality of rays of light (for example, LL1, LL2, LL3, hereinafter, denoted as LL1 to LL3 as needed) forming different angles of view of an angle of view region of the left half of the full angle of view of the image I, the plurality of rays of light ((for example, LL1 to LL3) forming a left half space region) passing through the collimating lens 210. Hereinafter, the light group including the plurality of rays of light (for example, LL1 to LL3) is also referred to as a first light group.

The second reflector 220-2 is disposed on an optical path of a plurality of rays of light (for example, RL1, RL2, RL3, hereinafter, denoted as RL1 to RL3 as needed) forming different angles of view of an angle of view region of the right half of the full angle of view of the image I, the plurality of rays of light ((for example, RL1 to RL3) forming a right half space region) passing through the collimating lens 210. Hereinafter, the light group including the plurality of rays of light (for example, RL1 to RL3) is also referred to as a second light group.

Here, LL1 is, for example, a ray of light that forms a rightmost angle of view (approximately center angle of view of the full angle of view) of the angle of view region of the left half of the full angle of view of the image I. LL2 is, for example, a ray of light that forms a center angle of view of the angle of view region of the left half of the full angle of view of the image I. LL3 is, for example, a ray of light that forms a leftmost angle of view (leftmost angle of view of the full angle of view) of the angle of view region of the left half of the full angle of view of the image I. RL1 is, for example, a ray of light that forms a leftmost angle of view (approximately center angle of view of the full angle of view) of the angle of view region of the right half of the full angle of view of the image I. LL2 is, for example, a ray of light that forms a center angle of view of the angle of view region of the right half of the full angle of view of the image I. LL3 is, for example, a ray of light that forms a rightmost angle of view (rightmost angle of view of the full angle of view) of the angle of view region of the right half of the full angle of view of the image I.

An orientation (angle) of each of the first and second reflectors 220-1, 220-2 relative to the surface (flat surface), adjacent to the eyeball EB, of the light guide plate 310-1 is set such that each of the first and second reflectors 220-1, 220-2 reflects the plurality of corresponding incident rays of light to cause the plurality of rays of light to impinge on the light guide plate 310-1 at a predetermined incident angle. The predetermined incident angle is an incident angle that causes the plurality of corresponding rays of light to totally reflect off the surface, adjacent to the eyeball EB, of the light guide plate 310-1.

More specifically, the first reflector 220-1 reflects the plurality of corresponding rays of light (for example, LL1, LL2, LL3) in a first direction. The plurality of rays of light reflected in the first direction impinges on the surface, adjacent to the eyeball EB, of the light guide plate 310-1 at an incident angle that causes the plurality of rays of light to totally reflect at a total reflection angle θ1 off the surface, adjacent to the eyeball EB, of the light guide plate 310-1. The plurality of rays of light (for example, LL1, LL2, LL3) incident on the surface, adjacent to the eyeball EB, of the light guide plate 310-1 at the incident angle is totally reflected at the total reflection angle θ1 by the surface, adjacent to the eyeball EB, of the light guide plate 310-1 and then propagates rightward while totally reflecting at the total reflection angle θ1 in the flat plate part 310-1c of the light guide plate 310-1 to impinge on the light diffraction system 400-1 at the incident angle θ1.

The second reflector 220-2 reflects the plurality of corresponding rays of light (for example, RL1, RL2, RL3) in a second direction. The plurality of rays of light reflected in the second direction impinges on the surface, adjacent to the eyeball EB, of the light guide plate 310-1 at an incident angle that causes the plurality of rays of light to totally reflect at a total reflection angle θ2 (<θ1) off the surface, adjacent to the eyeball EB, of the light guide plate 310-1. The plurality of rays of light (for example, RL1, RL2, RL3) incident on the surface, adjacent to the eyeball EB, of the light guide plate 310-1 at the incident angle is totally reflected at the total reflection angle θ2 by the surface, adjacent to the eyeball EB, of the light guide plate 310-1 and then propagates while totally reflecting at the total reflection angle θ2 in the flat plate part 310-1c of the light guide plate 310-1 to impinge on the light diffraction system 400-1 at the incident angle θ2.

According to the present embodiment, as an example, θ1 is set at 62°, and θ2 is set at 44° with respect to the thickness (for example, 3.1 mm) of the flat plate part 310-1 c of the light guide plate 310-1. Accordingly, a light guide distance of light in the light guide plate 310-1 is optimized.

(Light Diffraction System)

The light diffraction system 400-1 diffracts the plurality of rays light (for example, LL1 to RL3) guided by the light guide system 300-1 to cause at least two of the plurality of rays of light to impinge on the eyeball EB in different directions.

As an example, the light diffraction system 400-1 has incident angle selectivity for at least one (for example, θ1, θ2) of the incident angles at which the plurality of rays of light guided by the light guide system 300-1 impinges on the light diffraction system 400-1.

As an example, at least two (for example, θ1 and θ2) of the incident angles (for example, θ1, θ2) of the plurality of rays of light (for example, LL1 to RL3) that impinge on the light diffraction system 400-1 are different from each other.

As an example, at least two of the rays of light that each impinge on the light diffraction system 400-1 at a corresponding one of the at least two incident angles (for example, θ1, θ2) are identical in wavelength to each other.

As an example, the light diffraction system 400-1 has incident angle selectivity for a plurality of (for example, two) incident angles (for example, θ1, θ2).

More specifically, the light diffraction system 400-1 includes a plurality of (for example, two) diffraction parts (for example, first and second diffraction parts 410-1, 410-2) each having incident angle selectivity for at least one incident angle (for example, one incident angle) of the at least two incident angles (for example, θ1, θ2).

For example, each diffraction part may be formed by a processed surface of the light guide plate 310-1, or may be attached to a surface of the light guide plate 310-1. Each diffraction part is also referred to as, for example, a diffractive optical element (DOE) or a holographic optical element (HOE).

Here, each diffraction part is of a reflection type as an example.

As an example, the first and second diffraction parts 410-1, 410-2 are arranged so as to face the eyeball EB with the light guide plate 310-1 interposed between the first and second diffraction parts 410-1, 410-2 and the eyeball EB.

More specifically, the first and second diffraction parts 410-1, 410-2 are arranged, for example, on a surface, remote from the eyeball EB, of the right end of the light guide plate 310-1.

As an example, the first and second diffraction parts 410-1, 410-2 are arranged side by side in a left-right direction (for example, arranged adjacent to each other). Here, the first diffraction part 410-1 is disposed on the left side, and the second diffraction part 410-2 is disposed on the right side.

Each of the first and second diffraction parts 410-1, 410-2 has incident angle selectivity for a different incident angle of the at least two incident angles (for example, θ1, θ2).

Specifically, the first diffraction part 410-1 has incident angle selectivity for the incident angle θ1. The first diffraction part 410-1 has no incident angle selectivity for the incident angle θ2.

The second diffraction part 410-2 has incident angle selectivity for the incident angle θ2. The second diffraction part 410-2 has no incident angle selectivity for the incident angle θ1.

More specifically, the first diffraction part 410-1 selectively diffracts the plurality of rays of light (for example, LL1 to LL3) that forms the angle of view region of the left half of the image I and is incident at the incident angle θ1 of the plurality of incident rays of light. The first diffraction part 410-1 is set so as to make diffraction efficiency become approximately 100% for rays of light incident at the incident angle θ1, for example.

The second diffraction part 410-2 selectively diffracts the plurality of rays of light (for example, RL1 to RL3) that forms the angle of view region of the right half of the image I and is incident at the incident angle θ2 of the plurality of incident rays of light. The second diffraction part 410-2 is set so as to make diffraction efficiency become approximately 100% for rays of light incident at the incident angle θ2, for example.

Note that, for example, the second diffraction part 410-2 need not have incident angle selectivity for the incident angle θ2.

At least two light groups (for example, the light group of LL1 to LL3 and the light group of RL1 to RL3) that impinge on the light diffraction system 400-1 at the at least two incident angles (for example, θ1, θ2) are at least two light groups that have propagated while totally reflecting at mutually different total reflection angles θ1, θ2 in the light guide plate 310-1.

The at least two light groups (for example, the light group of LL1 to LL3 and the light group RL1 to RL3) that impinge on the light diffraction system 400-1 at the at least two incident angles (for example, θ1, θ2) are at least two light groups that has caused, by the incident optical system 200-1, to impinge on the surface, adjacent to the eyeball EB, of the light guide plate 310-1 at mutually different incident angles θ1, θ2.

Here, it is desirable that all the rays of light (for example, LL1 to LL3) reflected by the first reflector 220-1 impinge on the corresponding first diffraction part 410-1, and all the rays of light (for example, RL1 to RL3) reflected by the second reflector 220-2 impinge on the corresponding second diffraction part 410-2.

For this purpose, it is required that at least two rays of light that impinge on the light diffraction system 400-1 at the at least two incident angles (for example, θ1, θ2) have a positional relation of the position of incidence on the light guide plate 310-1 and a positional relation of the position of incidence on the light diffraction system 400-1 coincident with each other.

Therefore, the plurality of diffraction parts (for example, the first and second diffraction parts 410-1, 410-2) is each provided at a position that coincides with a common multiple of a total reflection cycle in the light guide plate 310-1 of a corresponding one of at least two rays of light that impinge on the light diffraction system 400-1 at the at least two incident angles (for example, θ1, θ2).

It is therefore possible to reduce a deviation between the positional relation of the position where the at least two rays of light are incident on the light guide plate 310-1 and the positional relation of the position where the at least two rays of light are incident on the light diffraction system 400-1, the deviation being caused by a difference in total reflection cycle in the light guide plate 310-1 between the at least two rays of light.

Note that the common multiple is preferably a least common multiple.

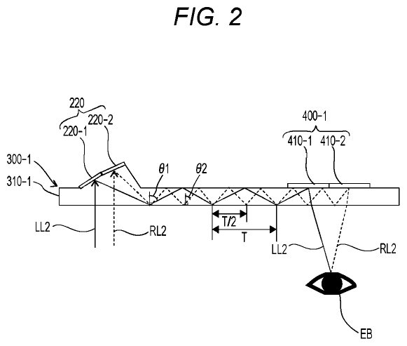

Moreover, as illustrated in FIG. 2, it is preferable that ½ (T/2) of a total reflection cycle T of a ray of light (ray of light that totally reflects at the total reflection angle θ1, for example, LL2) having the longest total reflection cycle out of the at least two rays of light that each impinge on the light diffraction system 400-1 at a corresponding one of the at least two incident angles (for example, θ1, θ2) coincides with an integral multiple (for example, 1 time) of the total reflection cycle of a ray of light (ray of light that totally reflects at the total reflection angle θ2, for example, the ray of light RL2) other than the ray of light having the longest total reflection cycle out of the at least two rays of light.

In this case, adjusting the arrangement and the left and right widths of each of the diffraction parts of the light diffraction system 400-1 allows each of the plurality of rays of light (for example, LL1 to RL3) that forms different angles of view of the image I to impinge on a desired position in the left-right direction of a corresponding diffraction part (position where a ray of light that can form a corresponding angle of view and impinges on the eyeball EB).

Note that FIG. 2 illustrates neither the image formation system 100-1 nor the collimating lens 210 of the incident optical system 200-1.

Specifically, it is possible to make a center position of the first diffraction part 410-1 in the left-right direction coincident with a total reflection position of the ray of light LL2 and to make a center position of the second diffraction part 410-2 in the left-right direction coincident with a total reflection position of the ray of light RL2.

It is therefore possible to cause each of the rays of light LL2, RL2 to impinge on a desired position (for example, the center position in the left-right direction) of a corresponding one of the first and second diffraction part 410-1, 410-2, for example.

As illustrated in FIG. 1, it is possible to make a right end position of the first diffraction part 410-1 coincident with a total reflection position of the ray of light LL1 and to make a left end position of the second diffraction part 410-2 coincident with a total reflection position of the ray of light RL1, for example. It is therefore possible to cause the ray of light LL1 to impinge on a desired position (for example, the right end position) of the corresponding first diffraction part 410-1 and to cause the ray of light RL1 to impinge on a desired position (for example, the left end position) of the corresponding second diffraction part 410-2, for example.

For example, it is possible to make the left end position of the first diffraction part 410-1 coincident with a total reflection position of the ray of light LL3 and to make the right end position of the second diffraction part 410-2 coincident with a total reflection position of the ray of light RL3, for example. It is therefore possible to cause the ray of light LL3 to impinge on a desired position (for example, the left end position) of the corresponding first diffraction part 410-1 and to cause the ray of light RL3 to impinge on a desired position (for example, the right end position) of the corresponding second diffraction part 410-2.

In each diffraction part, diffraction power for diffracting a corresponding ray of light is distributed in an in-plane direction. A diffraction direction of each ray of light diffracted by a corresponding diffraction part (a direction in which the ray of light diffracted by the corresponding diffraction part impinges on the surface, adjacent to the eyeball EB, of the light guide plate 310-1 or the surface remote from the eyeball EB) is a direction that does not satisfy a condition of total reflection in the light guide plate 310-1.

More specifically, the light diffraction system 400-1 has a diffraction power distribution that causes the plurality of rays of light (for example, LL1 to RL3) to impinge on the eyeball EB at different angles of view.

Specifically, the first diffraction part 410-1 has a diffraction power distribution so as to diffract the ray of light LL3 incident on the left end position to form a left maximum angle of view, diffracts the ray of light LL1 incident on the right end position to form an approximately center angle of view, and diffracts the ray of light LL2 incident on the center position to form an intermediate angle of view between the left maximum angle of view and the approximately center angle of view.

The second diffraction part 410-2 has a diffraction power distribution so as to diffract the ray of light RL3 incident on the right end position to form a right maximum angle of view, diffracts the ray of light RL1 incident on the left end position to form an approximately center angle of view, and diffracts the ray of light RL2 incident on the center position to form an intermediate angle of view between the left maximum angle of view and the approximately center angle of view.

(Control System) The control system 500 controls, in a centralized manner, the whole of the image display device 10-1. The control system 500 is implemented by hardware such as a CPU and a chip set.

The control system 500 generates modulation data on the basis of image data input from an external device or input over a network, and transmits the modulation data to the light source drive circuit.

2. <Image Display Processing>

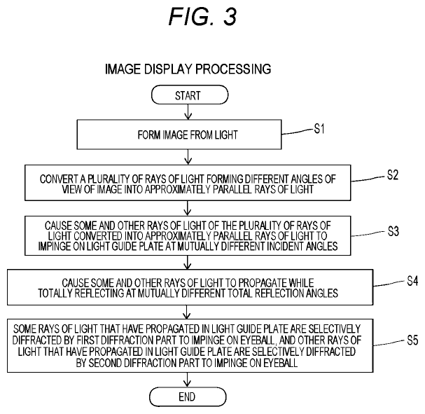

Hereinafter, image display processing that is performed using the image display device 10-1 according to the first embodiment will be described with reference to the flowchart of FIG. 3. The image display processing is an example of an image display method according to the present technology.

In a first step S1, as illustrated in FIG. 1, the image formation system 100-1 forms the image I from light. Specifically, the control system 500 synchronously controls the light source 110 and the light deflector 130 so as to cause the light deflector 130 to deflect and scan the light emitted from the light source 110 and passing through the optical element 120 to form the image I.

In the next step S2, the collimating lens 210 of the incident optical system 200-1 converts a plurality of rays of light forming different angles of view of the image I into approximately parallel rays of light. The plurality of rays of light converted into approximately parallel rays of light passes through the left end of the surface, adjacent to the eyeball EB, of the light guide plate 310-1 to impinge on the composite mirror 220.

In the next step S3, the composite mirror 220 of the incident optical system 200-1 causes some (for example, LL1 to LL3) of the plurality of rays of light converted into approximately parallel rays of light (for example, LL1 to RL3) and the others (for example, RL1 to RL3) of the plurality of rays of light to impinge on the surface, adjacent to the eyeball EB, of the light guide plate 310-1 at mutually different incident angles.

Specifically, the first reflector 220-1 of the composite mirror 220 reflects the some rays of light (for example, LL1 to LL3) to cause the rays of light to impinge on the surface, adjacent to the eyeball EB, of the light guide plate 310-1 at an incident angle that causes the rays of light to totally reflect in the light guide plate 310-1 at the total reflection angle θ1. The second reflector 220-2 of the composite mirror 220 reflects the other rays of light (for example, RL1 to RL3) to cause the rays of light to impinge on the surface, adjacent to the eyeball EB, of the light guide plate 310-1 at an incident angle that causes the rays of light to totally reflect in the light guide plate 310-1 at the total reflection angle θ2.

In the next step S4, the light guide plate 310-1 causes some rays of light (for example, LL1 to LL3) and the other rays of light (for example, RL1 to RL3) to propagate while totally reflecting at mutually different total reflection angles.

Specifically, the light guide plate 310-1 causes some rays of light (for example, LL1 to LL3) to propagate while totally reflecting at the total reflection angle θ1 and causes the other rays of light (for example, RL1 to RL3) to propagate while totally reflecting at the total reflection angle θ2.

In the next step S5, some rays of light (for example, LL1 to LL3) that have propagated in the light guide plate 310-1 are selectively diffracted by the first diffraction part 410-1 to impinge on the eyeball EB, and the other rays of light (for example, RL1 to RL3) that have propagated in the light guide plate 310-1 are selectively diffracted by the second diffraction part 410-2 to impinge on the eyeball EB.

Specifically, for example, the ray of light LL1 that has propagated in the light guide plate 310-1 at the total reflection angle θ1 impinges on the right end position of the corresponding first diffraction part 410-1 at the incident angle θ1, and then reflected and diffracted in a direction approximately parallel to the normal direction of the flat plate part 310-1c of the light guide plate 310-1 at the right end position to impinge on the eyeball EB, thereby forming the approximately center angle of view.

For example, the ray of light LL3 that has propagated in the light guide plate 310-1 at the total reflection angle θ1 impinges on the left end position of the corresponding first diffraction part 410-1 at the incident angle θ1, and is reflected and diffracted at the left end position and then refracted by the surface, adjacent to the eyeball EB, of the light guide plate 310-1 to impinge on the eyeball EB, thereby forming the left maximum angle of view.

For example, the ray of light LL2 that has propagated in the light guide plate 310-1 at the total reflection angle θ1 impinges on the center position of the corresponding first diffraction part 410-1 at the incident angle θ1, and is reflected and diffracted at the approximately center position and then refracted by the surface, adjacent to the eyeball EB, of the light guide plate 310-1 to impinge on the eyeball EB, thereby forming the intermediate angle of view between the left maximum angle of view and the approximately center angle of view.

Here, even if some rays of light (for example, RL1 to RL3) that have propagated in the light guide plate 310-1 at the total reflection angle θ2 impinge on the position of the light guide plate 310-1 where the first diffraction part 410-1 is provided, the rays of light are not diffracted by the first diffraction part 410-1 having no incident angle selectivity for the incident angle θ2 but are totally reflected by the light guide plate 310-1.

For example, the ray of light RL1 that has propagated in the light guide plate 310-1 at the total reflection angle θ2 impinges on the left end position of the corresponding second diffraction part 410-2 at the incident angle θ2, and is then reflected and diffracted in a direction approximately parallel to the normal direction of the flat plate part 310-1c of the light guide plate 310-1 at the left end position to impinge on the eyeball EB, thereby forming the approximately center angle of view.

For example, the ray of light RL3 that has propagated in the light guide plate 310-1 at the total reflection angle θ2 impinges on the right end position of the corresponding second diffraction part 410-2 at the incident angle θ2, and is reflected and diffracted at the right end position and then refracted by the surface, adjacent to the eyeball EB, of the light guide plate 310-1 to impinge on the eyeball EB, thereby forming the right maximum angle of view.

For example, the ray of light RL2 that has propagated in the light guide plate 310-1 at the total reflection angle θ2 impinges on the center position of the corresponding second diffraction part 410-2 at the incident angle θ2, and is reflected and diffracted at the approximately center position and then refracted by the surface, adjacent to the eyeball EB, of the light guide plate 310-1 to impinge on the eyeball EB, thereby forming the intermediate angle of view between the right maximum angle of view and the approximately center angle of view.

As described above, the plurality of rays of light (for example, LL1 to RL3) forming different angles of view of the image I impinges on the eyeball EB in different directions (for example, at different angles of view). This allows the image I to be visually recognized by the user (to be displayed for the user) at a wide angle of view.

3. <Effects Produced by Image Display Device According to First Embodiment of Present Technology>

The image display device 10-1 according to the first embodiment includes the image formation system 100-1 that forms the image I from light, the light guide system 300-1, the incident optical system 200-1 that causes a plurality of ray of light forming different angles of view of the image I to impinge on the light guide system 300-1, and the light diffraction system 400-1 that diffracts the plurality of rays of light guided by the light guide system 300-1 to cause the plurality of rays of light to impinge on the eyeball EB in different directions. The light diffraction system 400-1 has incident angle selectivity for at least one of incident angles at which the plurality of rays of light guided by the light guide system 300-1 impinges on the light diffraction system 400-1.

Here, the light diffraction system 400-1 has incident angle selectivity for all (for example, θ1 and θ2) of the incident angles (for example, θ1 and θ2) at which the plurality of rays of light guided by the light guide system 300-1 impinges on the light diffraction system 400-1, so that it is possible to diffract the plurality of rays of light sequentially and selectively.

On the other hand, if the light diffraction system 400-1 has incident angle selectivity for only one (for example, θ1 or θ2) of the incident angles (for example, θ1 and θ2) at which the plurality of rays of light guided by the light guide system 300-1 impinges on the light diffraction system 400-1, it is possible to selectively diffract the rays of light incident on the light diffraction system 400-1 at the one of the incident angles (for example, one of θ1 or θ2) of the plurality of rays of light and to diffract rays of light incident on the light diffraction system 400-1 at the other of the incident angles (for example, the other of θ1 or θ2) of the plurality of rays of light.

In either case, according to the image display device 10-1, it is possible to provide an image display device capable of displaying an image at a wide angle of view while minimizing crosstalk. Moreover, according to the image display device 10-1, it is possible to suppress an increase in size.

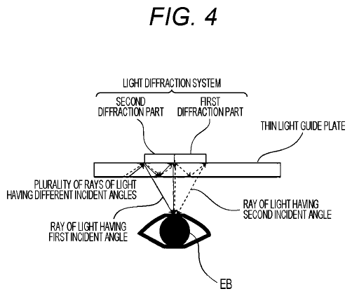

To give further details, the image display device 10-1 can form different angles of view of an image and cause the light diffraction system including the first and second diffraction parts to selectively diffract a plurality of rays of light incident at different incident angles (for example, rays of light at first and second incident angles), for example, as illustrated in FIG. 4. Therefore, rays of light having different angles of view information of an image impinge on the eyeball EB in different directions, so that it is possible to form a wide angle of view while minimizing crosstalk even if a deflection width of rays of light when guided by the light guide plate is small (for example, even if the light guide plate is thin).

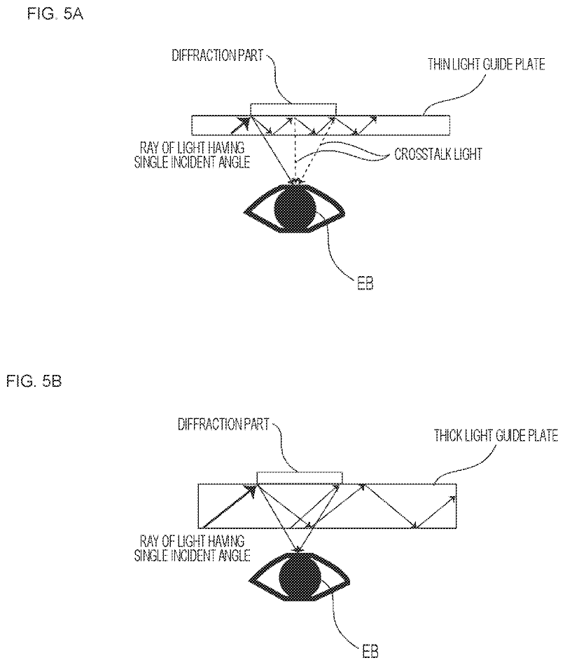

On the other hand, for example, as in a first comparative example illustrated in FIG. 5A, in a case where light of a single incident angle is diffracted by a diffraction part to form the full angle of view the same as the full angle of view illustrated in FIG. 4, if the deflection width of light when guided by the light guide plate is small (for example, if the light guide plate is thin), light having the same angle of view information impinges on the eyeball EB in a different direction, and crosstalk occurs accordingly. Therefore, in order to prevent the occurrence of crosstalk, it is necessary to increase the light deflection width (for example, to increase the thickness of the light guide plate) as in a second comparative example illustrated in FIG. 5B. This, however, makes the device larger in size.

The at least two (for example, θ1, θ2) of the incident angles at which the plurality of rays of light impinges on the light diffraction system 400-1 are different from each other. This makes it possible to reliably and selectively diffract a ray of light that impinges on the light diffraction system 400-1 at at least one incident angle of the plurality of rays of light.

The light diffraction system 400-1 includes a plurality of diffraction parts (for example, the first and second diffraction parts 410-1, 410-2) having incident angle selectivity for at least one incident angle of the at least two incident angles (for example, θ1, θ2). This allows a ray of light that impinges on the light diffraction system 400-1 at at least one incident angle to be selectively diffracted by a corresponding diffraction part. As a result, it is possible to make the angle of view wider while minimizing crosstalk.

At least two diffraction parts of the plurality of diffraction parts have incident angle selectivity for different incident angles of the at least two incident angles (for example, θ1, θ2). This makes it possible to reliably and selectively diffract at least two rays of light incident on the light diffraction system 400-1 at the at least two incident angles of the plurality of rays of light.

The light guide system 300-1 includes the light guide plate 310-1, and at least two rays of light that impinge on the light diffraction system 400-1 at the at least two incident angles (for example, θ1, θ2) are at least two rays of light that has propagated while totally reflecting at mutually different total reflection angles in the light guide plate 310-1. This allows the at least two rays of light to propagate within the light guide plate 310-1, so that it is possible to minimize deterioration in beam quality.

The at least two rays of light that impinge on the light diffraction system 400-1 at the at least two incident angles (for example, θ1, θ2) are at least two rays of light that impinge on the light guide plate 310-1 at mutually different incident angles through the incident optical system 200-1. This allows the at least two rays of light to totally reflect at mutually different total reflection angles in the light guide plate 310-1.

The incident optical system 200-1 converts the plurality of rays of light (for example, LL1 to RL3) forming different angles of view of the image I into approximately parallel rays of light and causes the plurality of rays of light to impinge on the light guide plate 310-1. This makes it possible to convert each piece of angle of view information of the image I into space information and allocate the space information to information regarding a desired incident angle with respect to the light guide plate 310-1.

The incident optical system 200-1 includes the collimating lens 210 that converts the plurality of rays of light forming different angles of view of the image I into approximately parallel rays of light, and the composite mirror 220 that reflects the plurality of rays of light converted into the approximately parallel rays of light by the collimating lens 210 in different directions for each angle of view region (for each space region) to cause the plurality of rays of light to impinge on the light guide plate 310-1 at different incident angles. This allows the plurality of rays of light to impinge on, with high accuracy, the light guide plate 310-1 at different incident angles for each angle of view region.

Each of the plurality of diffraction parts is preferably provided at a position that coincides with a common multiple of a propagation distance in the light guide plate 310-1 of each of the at least two rays of light that each impinge on the light diffraction system 400-1 at a corresponding one of the at least two incident angles. This makes it possible to extract the at least two rays of light from at least two positions having a desired positional relation in the light guide plate 310-1.

The common multiple is preferably a least common multiple. This makes it possible to extract the at least two rays of light from the at least two positions having a desired positional relation in the light guide plate 310-1 while making the propagation distance in the light guide plate 310-1 of the at least two rays of light as short as possible.

It is preferable that ½ of the total reflection cycle of a ray of light having the longest total reflection cycle of the at least two rays of light that each impinge on the light diffraction system 400-1 at a corresponding one of the at least two incident angles (for example, θ1, θ2) coincide with an integral multiple of the total reflection cycle of a ray of light other than the ray of light having the longest total reflection cycle of the at least two rays of light. This allows each of the plurality of rays of light forming different angles of view of the image I to impinge on a desired position of a corresponding diffraction part (position where a ray of light that impinges on the eyeball EB while forming a corresponding angle of view can be generated).

Each of the plurality of diffraction parts is provided at at least a position on the surface, remote from the eyeball EB, of the light guide plate 310-1 where a ray of light impinges on the light diffraction system 400-1 at a corresponding incident angle. This allows a ray of light to impinge on the eyeball EB using, for example, a diffraction part of a reflection type, so that an image can be displayed (visually recognized) with outside light blocked.

The at least two rays of light that impinge on the light diffraction system 400-1 at the at least two incident angles are identical in wavelength to each other. This makes it possible to provide a display at a wide angle of view using single wavelength light.

The image display method using the image display device 10-1 according to the first embodiment includes forming the image I from light, causing a plurality of ray of light forming different angles of view of the image I to impinge on the light guide system 300-1, guiding, by the light guide system 300-1, the plurality of rays of light, and diffracting, by the light diffraction system 400-1, the plurality of rays of light guided in the guiding to cause the plurality of rays of light to impinge on the eyeball in different directions. The light diffraction system 400-1 has incident angle selectivity for at least one of incident angles at which the plurality of rays of light guided by the light guide system 300-1 impinges on the light diffraction system 400-1.

Here, the light diffraction system 400-1 has incident angle selectivity for all (for example, θ1 and θ2) of the incident angles (for example, θ1 and θ2) at which the plurality of rays of light guided by the light guide system 300-1 impinges on the light diffraction system 400-1, so that it is possible to diffract the plurality of rays of light sequentially and selectively.

On the other hand, if the light diffraction system 400-1 has incident angle selectivity for only one (for example, θ1 or θ2) of the incident angles (for example, θ1 and θ2) at which the plurality of rays of light guided by the light guide system 300-1 impinges on the light diffraction system 400-1, it is possible to selectively diffract the rays of light incident on the light diffraction system 400-1 at the one of the incident angles (for example, one of θ1 or θ2) of the plurality of rays of light and to diffract rays of light incident on the light diffraction system 400-1 at the other of the incident angles (for example, the other of θ1 or θ2) of the plurality of rays of light.

In either case, according to the image display method using the image display device 10-1, it is possible to provide an image display device capable of displaying an image at a wide angle of view while minimizing crosstalk.

In the image display method, at least two incident angles (for example, θ1, θ2) of the incident angles at which the plurality of rays of light impinges are different from each other. This makes it possible to reliably and selectively diffract a ray of light that impinges on the light diffraction system 400-1 at at least one incident angle of the plurality of rays of light.

The light diffraction system 400-1 has incident angle selectivity for at least one incident angle of the at least two incident angles (for example, θ1, θ2), and in the causing a plurality of rays of light to impinge, a ray of light incident on the light diffraction system 400-1 at at least one incident angle of the plurality of rays of light is selectively diffracted by the light diffraction system 400-1. This allows the ray of light incident on the light diffraction system 400-1 at the at least one incident angle to be selectively diffracted by the light diffraction system 400-1. As a result, it is possible to make the angle of view wider while minimizing crosstalk.

4. <Image Display Device According to Second Embodiment of Present Technology>

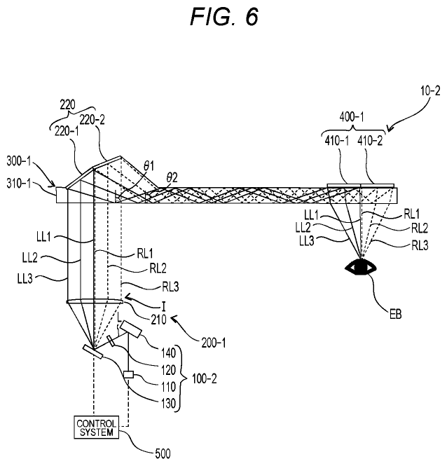

An image display device 10-2 according to a second embodiment of the present technology will be described with reference to FIG. 6.

As illustrated in FIG. 6, the image display device 10-2 according to the second embodiment is similar in configuration to the image display device 10-1 according to the first embodiment except for the configuration of the image formation system.

An image formation system 100-2 of the image display device 10-2 includes a chromatic aberration correction diffraction part 140 in addition to the configuration of the image formation system 100-1 of the image display device 10-1 according to the first embodiment.

The chromatic aberration correction diffraction part 140 has a function of correcting chromatic aberration caused by each diffraction part of the light diffraction system 400-1 provided on the light guide plate 310-1.

The chromatic aberration correction diffraction part 140 is preferably disposed on the optical path of the light L between the light source 110 and the light deflector 130. Here, as an example, the chromatic aberration correction diffraction part 140 is disposed on the optical path of the light L between the light source 110 and the optical element 120.

In the image display device 10-2, the light L emitted from the light source 110 is diffracted (for example, reflected and diffracted) while chromatic aberration is corrected by the chromatic aberration correction diffraction part 140 to impinge on the light deflector 130 through the optical element 120, thereby forming the image I. This allows the user to visually recognize the image in which chromatic aberration caused by the light diffraction system 400-1 is corrected.

The image display device 10-2 produces actions and effects similar to the actions and effects produced by the image display device 10-1 according to the first embodiment, and allows light for forming an image in which chromatic aberration is corrected to impinge on the eyeball EB, so that it is possible to display a color image with high quality.

5. <Image Display Device According to Third Embodiment of Present Technology>

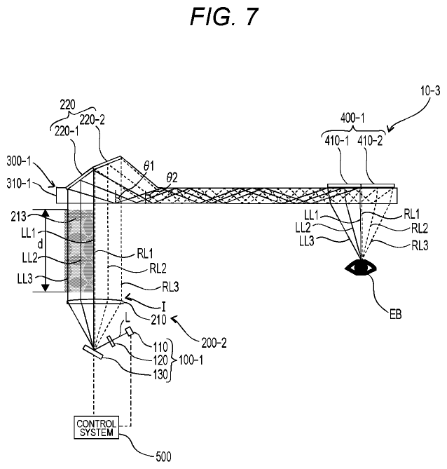

An image display device 10-3 according to a third embodiment of the present technology will be described with reference to FIG. 7.

As illustrated in FIG. 7, the image display device 10-3 according to the third embodiment is similar in configuration to the image display device 10-1 according to the first embodiment, and an incident optical system 200-2 includes a correction member 213 that corrects a difference in optical path length.

That is, the incident optical system 200-2 includes the correction member 213 that corrects a difference in optical path length between at least two rays of light that each impinge on the light diffraction system 400-1 at a corresponding one of at least two incident angles (for example, θ1, θ2), the optical path length being from a position of incidence on the light guide plate 310-1 to a corresponding diffraction part (for example, the first and second diffraction parts 410-1, 410-2).

The correction member 213 is only required to have a function of reducing the difference in optical path length, but preferably has a function of making the difference in optical path length approximately equal to zero.

Here, for light propagating while totally reflecting in the light guide plate, the smaller the total reflection angle, the longer the optical path length per total reflection cycle.

Therefore, the optical path length of each of the rays of light (for example, RL1 to RL3) that impinges on the light diffraction system 400-1 at the incident angle θ2 (<θ1), the optical path length being from the position of incidence on the light guide plate 310-1 to a corresponding second diffraction part 410-2, is longer than the optical path length of each of the rays of light (for example, LL1 to LL3) that impinges on the light diffraction system 400-1 at the incident angle θ1, the optical path length being from the position of incidence on the light guide plate 310-1 to a corresponding first diffraction part 410-1.

The rays of light propagating while totally reflecting in the light guide plate 310-1 propagate while diverging at a predetermined divergence angle. Therefore, a difference in optical path length between the rays of light that impinge on the light diffraction system 400-1 brings about a difference in beam diameter between beams that impinge on the light diffraction system 400-1. This causes the diffraction by the light diffraction system 400-1 to vary between incident beams, and the position of incidence on the eyeball EB varies accordingly. As a result, the quality of the display image deteriorates.

Therefore, the correction member 213 that corrects a difference in optical path length is disposed on the optical path of rays of light that impinge on the light diffraction system 400-1 at the incident angle θ1, that is, the plurality of rays of light (for example, LL1 to LL3) forming the angle of view region of the left half of the full angle of view of the image I.

More specifically, the correction member 213 is disposed between the left half of the collimating lens 210 and the light guide plate 310-1.

The correction member 213 includes, for example, a glass material having a refractive index n.

The correction member 213 corrects a difference (n−1)d in optical path length, the difference being obtained by subtracting d (optical path length in air) from a product nd (optical path length in the correction member 213) of the refractive index n and a length d in the optical axis direction of the collimating lens 210.

Here, the value of n and/or the value of d is set in accordance with a difference in optical path length between the plurality of rays of light that impinges on the light diffraction system 400-1 at a corresponding one of the incident angles θ1, θ2.

According to the image display device 10-3, a difference in optical path length between beams that impinge on the light diffraction system 400-1 at different incident angles is corrected, so that it is possible to reduce variations in beam diameter between the incident beams and in turn minimize deterioration in quality of the display image.

6. <Image Display Device According to Fourth Embodiment of Present Technology>

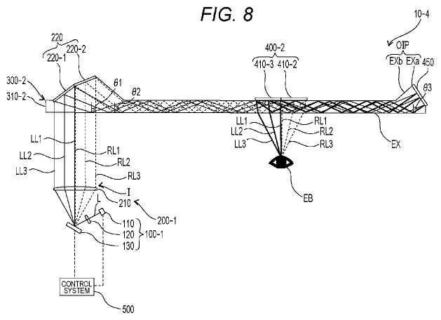

An image display device 10-4 according to a fourth embodiment of the present technology will be described with reference to FIG. 8.

In the image display device 10-4 according to the fourth embodiment, a light guide plate 310-2 of a light guide system 300-2 has an extension part EX extending to the right side beyond a position where a light diffraction system 400-2 is provided (position facing the eyeball EB).

As an example, the light diffraction system 400-2 includes the second diffraction part 410-2 having incident angle selectivity for the incident angle θ2 and a third diffraction part 410-3 having incident angle selectivity for an incident angle θ3 (≠θ1). The third diffraction part 410-3 has no incident angle selectivity for the incident angle θ1.

Here, as an example, the second and third diffraction parts 410-2, 410-3 are provided adjacent to each other in the left-right direction on the surface, remote from the eyeball EB, of the light guide plate 310-2 such that the second diffraction part 410-2 is disposed relatively on the right side, and the third diffraction part 410-3 is disposed relatively on the left side.

In the extension part EX, for example, an optical member installation part OIP is provided at the right end of the surface remote from the eyeball EB. The optical member installation part OIP includes an opening EXa and an inclined surface EXb. An optical member 450 that folds back the optical path is provided around the opening EXa so as to close the opening EXa. The inclined surface EXb is inclined so as to make its left end closer to the eyeball EB and is continuous with the surface (flat surface), remote from the eyeball EB, of the flat plate part. That is, the optical member 450 is provided on a side of the light guide plate 310-2 opposite from the position where the plurality of rays of light (for example, LL1 to RL3) impinges on the surface, adjacent to the eyeball EB, of the light guide plate 310-2 relative to the position where the light diffraction system 400-2 is provided.

Examples of the optical member 450 include a mirror (for example, a plane mirror).

The optical member 450 is preferably provided at a position where a difference in optical path length between at least two rays of light that each impinge on the light diffraction system 400-2 at a corresponding one of at least two incident angles is smaller, and is more preferably provided at a position where the difference in optical path length is approximately equal to zero. Note that the optical member 450 may be provided on the surface, adjacent to the eyeball EB, of the extension part EX.

The plurality of rays of light (for example, RL1 to RL3) forming the right half space region through the collimating lens 210 is reflected by the corresponding second reflector 220-2 to propagate while totally reflecting at the total reflection angle 02 in the light guide plate 310-2 and then reflected and diffracted toward the eyeball EB by the corresponding second diffraction part 410-2.

On the other hand, the plurality of rays of light (for example, LL1 to LL3) forming the left half space region through the collimating lens 210 is reflected by the corresponding first reflector 220-1 to propagate rightward while totally reflecting at the total reflection angle θ1 in the light guide plate 310-2 (totally reflecting even at the position where the light diffraction system 400-2 is provided) and then impinge on the optical member 450 provided at the right end of the extension part EX. The plurality of rays of light (for example, LL1 to LL3) incident on the optical member 450 has its optical path folded back by the optical member 450 (see thick solid lines). More specifically, the plurality of rays of light (for example, LL1 to LL3) incident on the optical member 450 is reflected by the optical member 450 to impinge on the surface, adjacent to the eyeball EB, of the light guide plate 310-2 at an incident angle that causes the plurality of rays of light to totally reflect at the total reflection angle θ3 in the light guide plate 310-2. The plurality of rays of light (for example, LL1 to LL3) incident on the surface, adjacent to the eyeball EB, of the light guide plate 310-2 after the optical path is folded back by the optical member 450 propagates leftward at the total reflection angle θ3 in the light guide plate 310-2 and is then reflected and diffracted toward the eyeball EB by the corresponding third diffraction part 410-3.

According to the image display device 10-4, of at least two light groups (for example, the light group of LL1 to LL3 and the light group of RL1 to RL3) that each impinge on the light diffraction system 400-2 at a corresponding one of at least two incident angles (for example, θ1, θ2), some rays of light (for example, the light group of LL1 to LL3) other than the rays of light that are the longest in optical path length (shortest optical path length) from the position of incidence on the light guide plate 310-2 to a corresponding diffraction part are diffracted by the corresponding third diffraction part 410-3 after the optical path is folded back by the optical member 450.

This makes it possible to reduce the difference in optical path length between the plurality of light groups (for example, the light group of LL1 to LL3 and the light group of RL1 to RL3), so that it is possible to minimize deterioration in image quality of the display image.

7. <Image Display Device According to Fifth Embodiment of Present Technology>

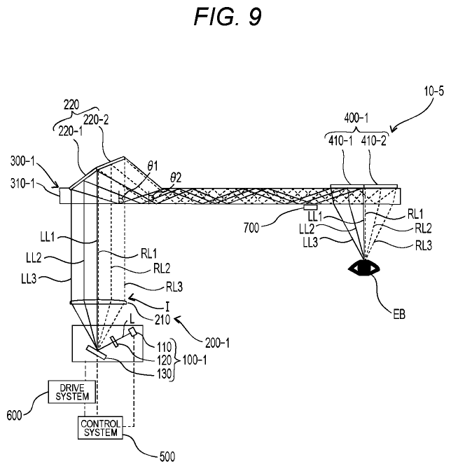

An image display device 10-5 according to a fifth embodiment of the present technology will be described below with reference to FIGS. 9 to 12.

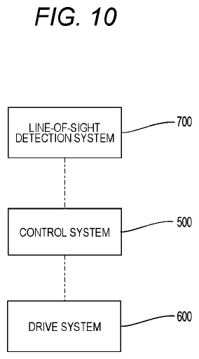

As illustrated in FIGS. 9 and 10, the image display device 10-5 according to the fifth embodiment is similar in configuration to the image display device 10-1 according to the first embodiment except that the position and/or orientation of the image formation system 100-1 can be controlled.

As an example, the image display device 10-5 includes a drive system 600 that drives the position of the image formation system 100-1 in a direction perpendicular to FIG. 9 (user's vertical field-of-view direction, for example, an up-down direction).

Examples of the drive system 600 include a linear motor, a combination of a rack-and-pinion mechanism and a drive source (for example, a motor), a combination of a ball screw mechanism and a drive source (for example, a motor), and the like.

The image display device 10-5 may further include a line-of-sight detection system 700.

The line-of-sight detection system 700 detects a line-of-sight that is an orientation of the eyeball EB and outputs the detection result to the control system 500.

As an example, the line-of-sight detection system 700 includes a light receiving/emitting unit and a signal processing unit that processes an output signal of the light receiving/emitting unit.

The light receiving/emitting unit includes a light emitting element that irradiates the eyeball EB with invisible light (for example, infrared light) and a light receiving element (for example, four-segmented photodiode (PD)) in which a plurality of (for example, four) light receiving regions (for example, photodiodes) is two-dimensionally arranged.

The signal processing unit processes output signals of the plurality of light receiving regions of the light receiving element and calculates a direction of the line-of-sight.

The control system 500 controls the drive system 600 on the basis of the detection result of the line-of-sight detection system 700 and/or an image display position.

First, a method for controlling, by the control system 500, the drive system 600 on the basis of the detection result of the line-of-sight detection system 700 will be briefly described.

A height position (position in the up-down direction) of the image formation system 100-1 when the detection result of the line-of-sight detection system 700 indicates that, for example, the eyeball EB is at the same height as the light diffraction system 400-1 is set as a reference position.

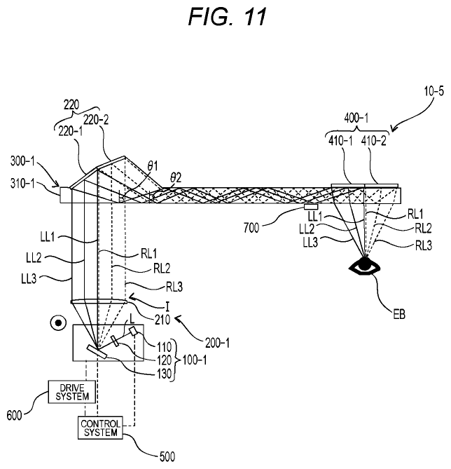

For example, as illustrated in FIG. 11, when the detection result of the line-of-sight detection system 700 indicates that the eyeball EB has moved upward from the reference position by a certain distance, the control system 500 controls the drive system 600 to move the image formation system 100-1 downward by a distance corresponding to the movement distance of the eyeball EB. This allows a position at which the plurality of rays of light diffracted by the light diffraction system 400-1 is concentrated to move upward by a distance corresponding to the movement distance of the eyeball EB.

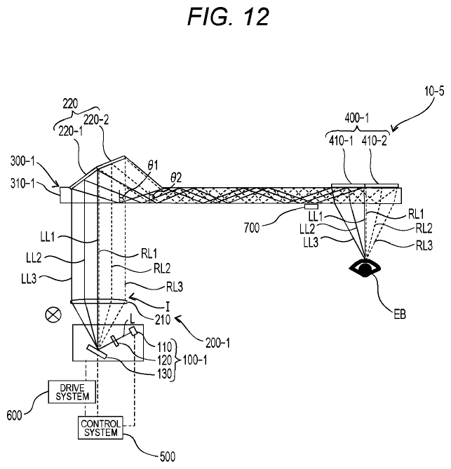

For example, as illustrated in FIG. 12, when the detection result of the line-of-sight detection system 700 indicates that the eyeball EB has moved downward from the reference position by a certain distance, the control system 500 controls the drive system 600 to move the image formation system 100-1 upward by a distance corresponding to the movement distance of the eyeball EB. This allows the position at which the plurality of rays of light diffracted by the light diffraction system 400-1 is concentrated to move downward by a distance corresponding to the movement distance of the eyeball EB.

As described above, the control system 500 moves the image formation system 100-1 in the up-down direction in accordance with a change in height position (position in the up-down direction) of the eyeball EB, so that the position at which the rays of light are concentrated by the light diffraction system 400-1 can follow the height position of the eyeball EB.

Next, a method for controlling, by the control system 500, the drive system 600 on the basis of the image display position will be briefly described. The line-of-sight detection system 700 need not be provided under this control method.

In the meantime, it is expected that the line-of-sight of the user moves in accordance with the position where the image is displayed (image display position). For example, in a case where the image is displayed on the upper side, it is expected that the line-of-sight of the user moves upward. Therefore, controlling the drive system 600 in accordance with a change in image display position allows the position at which the rays of light are concentrated by the light diffraction system 400-1 to move to a position corresponding to the direction of the line-of-sight (the orientation of the eyeball EB).

Specifically, the height position (position in the up-down direction) of the image formation system 100-1 when the image display position is at the same height as the light diffraction system 400-1 is set as the reference position.

In a case where the image display position moves upward from the reference position by a certain distance, the control system 500 controls the drive system 600 to move the image formation system 100-1 downward by a distance corresponding to the movement distance of the image display position. This allows the position at which the plurality of rays of light diffracted by the light diffraction system 400-1 is concentrated to move upward by a distance corresponding to the movement distance of the image display position.

In a case where the image display position moves downward from the reference position by a certain distance, the control system 500 controls the drive system 600 to move the image formation system 100-1 upward by a distance corresponding to the movement distance of the image display position. This allows the position at which the plurality of rays of light diffracted by the light diffraction system 400-1 is concentrated to move downward by a distance corresponding to the movement distance of the image display position.

According to the image display device 10-5, even if there is a positional deviation in the up-down direction between the eyeball EB and the image display device 10-5, the image can be displayed without disappearance of the image.

Note that, here, the drive system 600 is configured to be able to move the image formation system 100-1 up and down, but additionally or alternatively, the drive system 600 may be configured to be able to change the orientation of the image formation system 100-1 from a horizontal position to an obliquely upward position or an obliquely downward position.

8. <Image Display Device According to Sixth Embodiment of Present Technology>

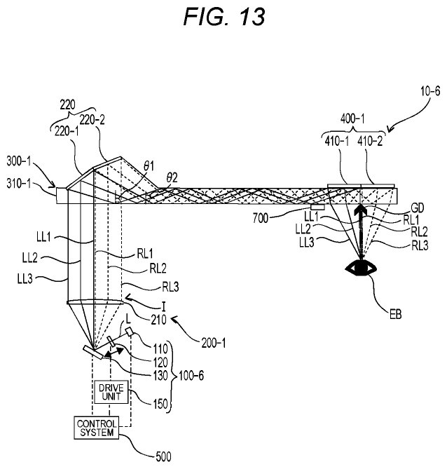

An image display device 10-6 according to a sixth embodiment of the present technology will be described below with reference to FIGS. 13 to 16.

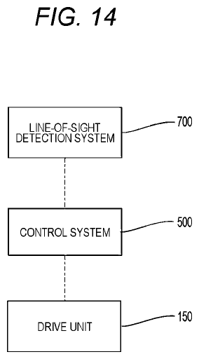

As illustrated in FIGS. 13 and 14, the image display device according to the sixth embodiment is similar in configuration to the image display device 10-1 according to the first embodiment except that an image formation system 100-6 is capable of moving the optical element 120 in an optical axis direction of the optical element 120.

As an example, the image formation system 100-6 includes a drive unit 150 that drives the optical element 120 in the optical axis direction of the optical element 120.

Examples of the drive unit 150 include a linear motor, a combination of a rack-and-pinion mechanism and a drive source (for example, a motor), a combination of a ball screw mechanism and a drive source (for example, a motor), and the like.

The image display device 10-6 may further include the line-of-sight detection system 700.

The line-of-sight detection system 700 detects a line-of-sight that is an orientation of the eyeball EB and outputs the detection result to the control system 500.

As an example, the line-of-sight detection system 700 includes a light receiving/emitting unit and a signal processing unit that processes an output signal of the light receiving/emitting unit.

The light receiving/emitting unit includes a light emitting element that irradiates the eyeball EB with invisible light (for example, infrared light) and a light receiving element (for example, four-segmented photodiode (PD)) in which a plurality of (for example, four) light receiving regions (for example, photodiodes) is two-dimensionally arranged.

The signal processing unit processes output signals of the plurality of light receiving regions of the light receiving element and calculates a direction of the line-of-sight.

The control system 500 controls the drive unit 150 on the basis of the detection result of the line-of-sight detection system 700 and/or the image display position.

First, a method for controlling, by the control system 500, the drive unit 150 on the basis of the detection result of the line-of-sight detection system 700 will be briefly described.

Specifically, the control system 500 adjusts the position of the optical element 120 in the optical axis direction by controlling the drive unit 150 in accordance with the detection result of the line-of-sight detection system 700 that indicates a direction of the line-of-sight GD (also referred to as a gaze direction GD) that is the orientation of the eyeball EB.

For example, as illustrated in FIG. 13, first, the position of the optical element 120 that makes the divergence angle and the cross-sectional shape of the rays of light (for example, LL1 and RL1) that are diffracted by the first and second diffraction parts 410-1, 410-2 along the gaze direction GD (for example, in a direction approximately perpendicular to the light guide plate 310-1) to impinge on the eyeball EB when the gaze direction GD is directed toward the center (front) appropriate (preferably the most suitable) is set as the reference position.

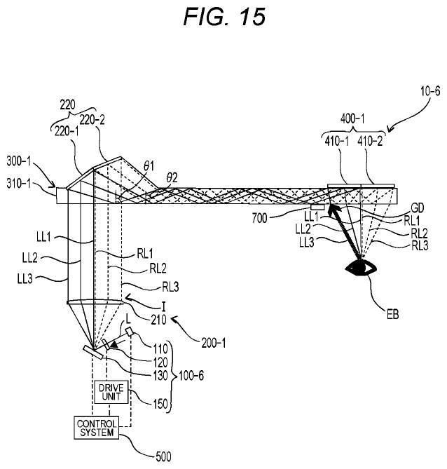

For example, as illustrated in FIG. 15, when the gaze direction GD is directed leftward, the control system 500 controls the drive unit 150 to move the optical element 120 from the reference position toward the light deflector 130 to change the position at which the ray of light (for example, LL3) is concentrated by the optical element 120 (for example, to move the position at which the ray of light LL3 is concentrated to the front side on the optical path) such that the divergence angle and the cross-sectional shape of the ray of light (for example, LL3) that impinges along the gaze direction GD become appropriate (preferably the most suitable).

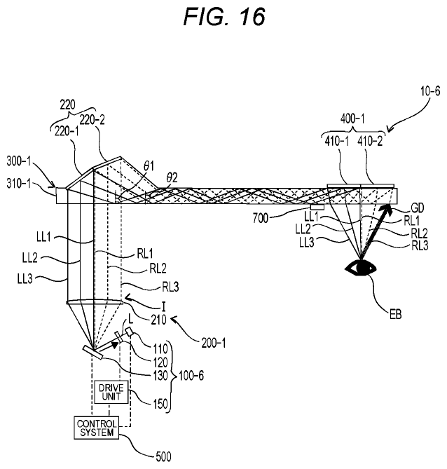

For example, as illustrated in FIG. 16, when the gaze direction GD is directed rightward, the control system 500 controls the drive unit 150 to move the optical element 120 from the reference position toward the light source 110 to change the position at which the ray of light (for example, RL3) is concentrated by the optical element 120 (for example, to move the position at which the ray of light RL3 is concentrated to the back side on the optical path) such that the divergence angle and the cross-sectional shape of the ray of light (for example, RL3) that impinges along the gaze direction GD become appropriate (preferably the most suitable).

Next, a method for controlling, by the control system 500, the drive unit 150 on the basis of the image display position will be briefly described. The line-of-sight detection system 700 need not be provided under this control method.

Specifically, the control system 500 adjusts the position of the optical element 120 in the optical axis direction by controlling the drive unit 150 in accordance with the image display position.

For example, first, when the image display position is located in front of the eyeball EB, the position of the optical element 120 where the divergence angle and the cross-sectional shape of the rays of light diffracted by the first and second diffraction part 410-1, 410-2 toward the eyeball EB are appropriate (preferably the most suitable) is set as the reference position.

For example, when the image display position moves from the front of the eyeball EB to the left side, the control system 500 controls the drive unit 150 to move the optical element 120 from the reference position toward the light deflector 130 to change the position at which the rays of light are concentrated by the optical element 120 (for example, to move the position at which the rays of light are concentrated to the front side on the optical path) such that the divergence angle and the cross-sectional shape of the rays of light diffracted by the first and second diffraction parts 410-1, 410-2 toward the eyeball EB become appropriate (preferably the most suitable).

For example, when the image display position moves from the front of the eyeball EB to the right side, the control system 500 controls the drive unit 150 to move the optical element 120 from the reference position toward the light source 110 to change the position at which the rays of light are concentrated by the optical element 120 (for example, to move the position at which the rays of light are concentrated to the back side on the optical path) such that the divergence angle and the cross-sectional shape of the rays of light diffracted by the first and second diffraction parts 410-1, 410-2 toward the eyeball EB become appropriate (preferably the most suitable).

According to the image display device 10-6, the divergence angle and the cross-sectional shape of the rays of light that impinge on the eyeball EB in any line-of-sight direction are optimized, so that it is possible to visually recognize an image with high quality regardless of the line-of-sight direction.

9. <Image Display Device According to Seventh Embodiment of Present Technology>

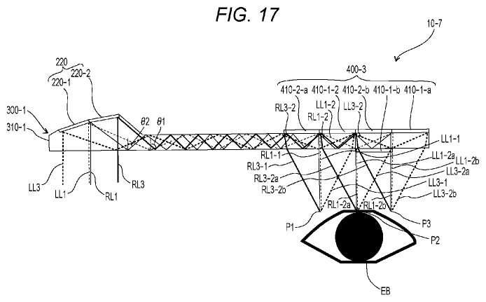

An image display device 10-7 according to a seventh embodiment of the present technology will be described below with reference to FIGS. 17 to 19.

As illustrated in FIG. 17, the image display device 10-7 according to the seventh embodiment is similar in configuration to the image display device 10-1 according to the first embodiment except that a configuration of a light diffraction system 400-3 is different.

FIG. 17 illustrates neither the image formation system 100-1 nor the collimating lens 210 of the incident optical system 200-1.

In the image display device 10-7 according to the seventh embodiment, the light diffraction system 400-3 includes, as an example, a diffraction part group including two first diffraction parts 410-1 (410-1-a, 410-1-b), two second diffraction parts 410-2 (410-2-a, 410-2-b), and one fourth diffraction part 410-1-2.

In the light diffraction system 400-3, one second diffraction part 410-2-a, the fourth diffraction part 410-1-2, the other second diffraction part 410-2-b, and one first diffraction part 410-1-a are arranged (adjacent to each other) in this order from the left side to the right side on the surface, remote from the eyeball EB, of the light guide plate 310-1.

The other second diffraction part 410-1-b is disposed at a position of the surface, adjacent to the eyeball EB, of the light guide plate 310-1 so as to face the other second diffraction part 410-2-b.

The one first diffraction part 410-1-a, each of the second diffraction parts 410-2, and the fourth diffraction part 410-1-2 are diffraction parts of a reflection type.

The other first diffraction part 410-1-b is a diffraction part of a transmission type.

The fourth diffraction part 410-1-2 has at least two diffraction structures laminated in the thickness direction of the light guide plate 310-1. The at least two diffraction structures have incident angle selectivity for at least two incident angles (for example, θ1, θ2).

Note that, in the fourth diffraction part 410-1-2, at least two diffraction patterns having incident angle selectivity for the at least two incident angles (for example, θ1, θ2) may be formed instead of the at least two diffraction structures.

In the light diffraction system 400-3, as an example, the one first diffraction part 410-1-a and the other first diffraction part 410-1-b of the plurality of (for example, five) diffraction parts have incident angle selectivity for the same incident angle θ1 of the at least two incident angles (for example, θ1, θ2).

In the light diffraction system 400-3, as an example, the one second diffraction parts 410-2-a and the other second diffraction parts 410-2-b of the plurality of (for example, five) diffraction parts have incident angle selectivity for the same incident angle θ2 of the at least two incident angles (for example, θ1, θ2).

In the light diffraction system 400-3, as an example, the first diffraction parts 410-1 and the second diffraction parts 410-2 of the plurality of (for example, five) diffraction parts have incident angle selectivity for different incident angles (θ1, θ2) of the at least two incident angles (for example, θ1, θ2).

In the light diffraction system 400-3, as an example, the first diffraction parts 410-1 and the fourth diffraction part 410-1-2 of the plurality of (for example, five) diffraction parts have incident angle selectivity for the same incident angle θ1 of the at least two incident angles (for example, θ1, θ2).

In the light diffraction system 400-3, as an example, the first diffraction parts 410-1 and the fourth diffraction part 410-1-2 of the plurality of (for example, five) diffraction parts have incident angle selectivity for different incident angles (θ1, θ2) of the at least two incident angles (for example, θ1, θ2).

In the light diffraction system 400-3, as an example, the second diffraction parts 410-2 and the fourth diffraction part 410-1-2 of the plurality of (for example, five) diffraction parts have incident angle selectivity for the same incident angle θ2 of the at least two incident angles (for example, θ1, θ2).

In the light diffraction system 400-3, as an example, the second diffraction parts 410-2 and the fourth diffraction part 410-1-2 of the plurality of (for example, five) diffraction parts have incident angle selectivity for different incident angles (θ1, θ2) of the at least two incident angles (for example, θ1, θ2).

The light diffraction system 400-3 diffracts a part of each of the plurality of rays of light (for example, LL1, LL3, RL1, RL3) guided by the light guide system 300-1 toward a plurality of different positions (for example, three light concentration positions P1, P2, P3) adjacent to the eyeball EB.

More specifically, at least two diffraction parts included in the diffraction part group of the light diffraction system 400-3 sequentially diffract different parts of each of at least two rays of light that impinge on the light diffraction system 400-3 at at least two incident angles (θ1, θ2) toward a plurality of different positions (for example, the three light concentration positions P1, P2, P3) adjacent to the eyeball EB.

Here, P1 is a leftmost light concentration position, P3 is a rightmost light concentration position, and P2 is a light concentration position between P1 and P (for example, an intermediate light concentration position).

A distance between the light concentration position P1 and the light concentration position P2 and a distance between the light concentration position P2 and the light concentration position P3 are set at the same distance (for example, 6 mm).

In the light diffraction system 400-3, diffraction efficiency of each diffraction part is set less than 100%, for example. Each diffraction part has a diffraction power distribution in an in-plane direction.

Hereinafter, the action of the image display device 10-7 will be described.

For example, the ray of light LL1 (thin dashed line in FIG. 17) forming the rightmost angle of view of the angle of view region of the left half of the full angle of view of the image I is reflected toward the light guide plate 310-1 by the first reflector 220-1 to impinge on the light guide plate 310-1 at the incident angle that causes the ray of light LL1 to totally reflect at the total reflection angle θ1 in the light guide plate 310-1. The ray of light LL1 that has propagated while totally reflecting at the total reflection angle θ1 in the light guide plate 310-1 impinges on the left end position of the fourth diffraction part 410-1-2. A part LL1-1 of the ray of light LL1 incident on the left end position of the fourth diffraction part 410-1-2 is reflected and diffracted at the left end position in a direction approximately perpendicular to the light guide plate 310-1 and then impinges on the light concentration position P1 through the surface, adjacent to the eyeball EB, of the light guide plate 310-1 to form the approximately center angle of view, and the other part LL1-2 is totally reflected by the surface, remote from the eyeball EB, of the light guide plate 310-1 to impinge on the left end position of the other first diffraction part 410-1-b. A part of LL1-2a of the ray of light LL1-2 incident on the left end position of the other first diffraction part 410-1-b is transmitted and diffracted at the left end position in a direction approximately perpendicular to the light guide plate 310-1 and then impinges on the light concentration position P2 to form the approximately center angle of view, and the other part LL1-2b is totally reflected by the surface, adjacent to the eyeball EB, of the light guide plate 310-1 to impinge on the left end position of the one first diffraction part 410-1-a. The ray of light LL1-2b incident on the left end position of the one first diffraction part 410-1-a is reflected and diffracted at the left end position in a direction approximately perpendicular to the light guide plate 310-1 and then impinges on the light concentration position P3 through the surface, adjacent to the eyeball EB, of the light guide plate 310-1 to form the approximately center angle of view.

For example, the ray of light LL3 (thick dashed line in FIG. 17) forming the leftmost angle of view of the angle of view region of the left half of the full angle of view of the image I is reflected toward the light guide plate 310-1 by the first reflector 220-1 to impinge on the light guide plate 310-1 at the incident angle that causes the ray of light LL3 to totally reflect at the total reflection angle θ1 in the light guide plate 310-1. The ray of light LL3 that has propagated while totally reflecting at the total reflection angle θ1 in the light guide plate 310-1 is totally reflected by the one second diffraction part 410-2-a and then totally reflected by the surface, adjacent to the eyeball EB, of the light guide plate 310-1 to impinge on the right end position of the fourth diffraction part 410-1-2. A part LL3-1 of the ray of light LL3 incident on the right end position of the fourth diffraction part 410-1-2 is reflected and diffracted at the right end position and then refracted by the surface adjacent to the eyeball EB to impinge on the light concentration position P1 to form the right maximum angle of view, and the other part LL3-2 is totally reflected by the surface of the light guide plate 310-1 remote from the eyeball EB to impinge on the right end position of the other first diffraction part 410-1-b. A part of LL3-2a of the ray of light LL3-2 incident on the right end position of the other first diffraction part 410-1-b is transmitted and diffracted at the right end position and then impinges on the light concentration position P2 to form the right maximum angle of view, and the other part LL3-2b is totally reflected by the surface, adjacent to the eyeball EB, of the light guide plate 310-1 to impinge on the right end position of the one first diffraction part 410-1-a. The ray of light LL3-2b incident on the right end position of the one first diffraction part 410-1-a is reflected and diffracted at the right end position and then refracted by the surface, adjacent to the eyeball EB, of the light guide plate 310-1 to impinge on the light concentration position P3 to form the right maximum angle of view.

For example, the ray of light RL1 (thin solid line in FIG. 17) forming the leftmost angle of view of the angle of view region of the right half of the full angle of view of the image I is reflected toward the light guide plate 310-1 by the second reflector 220-2 to impinge on the light guide plate 310-1 at the incident angle that causes the ray of light RL1 to totally reflect at the total reflection angle θ2 in the light guide plate 310-1. A part RL1-1 of the ray of light RL1 that has propagated while totally reflecting at the total reflection angle θ2 in the light guide plate 310-1 is reflected and diffracted at the right end position of the one second diffraction part 410-2-a in a direction approximately perpendicular to the light guide plate 310-1 and then impinges on the light concentration position P1 through the surface, adjacent to the eyeball EB, of the light guide plate 310-1 to form the approximately center angle of view, and the other part RL1-2 is totally reflected by the surface, remote from the eyeball EB, of the light guide plate 310-1 and then totally reflected by the surface adjacent to the eyeball EB to impinge on the right end position of the fourth diffraction part 410-1-2. A part RL1-2a of the ray of light RL1-2 incident on the right end position of the fourth diffraction part 410-1-2 is reflected and diffracted at the right end position of the fourth diffraction part 410-1-2 in a direction approximately perpendicular to the light guide plate 310-1 and then impinges on the light concentration position P2 through the surface of the light guide plate 310-1 adjacent to the eyeball EB to form the approximately center angle of view, and the other part RL1-2b is totally reflected by the surface of the light guide plate 310-1 remote from the eyeball EB and then totally reflected by the surface adjacent to the eyeball EB to impinge on the right end position of the other second diffraction part 410-2-b. The ray of light RL1-2b incident on the right end position of the other second diffraction part 410-2-b is reflected and diffracted at the right end position of the other second diffraction part 410-2-b in a direction approximately perpendicular to the light guide plate 310-1 to impinge on the light concentration position P3 through the surface, adjacent to the eyeball EB, of the light guide plate 310-1 to form the approximately center angle of view.

For example, the ray of light RL3 (thick solid line in FIG. 17) forming the rightmost angle of view of the angle of view region of the right half of the full angle of view of the image I is reflected toward the light guide plate 310-1 by the second reflector 220-2 to impinge on the light guide plate 310-1 at the incident angle that causes the ray of light RL3 to totally reflect at the total reflection angle θ2 in the light guide plate 310-1. The ray of light RL3 that has propagated while totally reflecting at the total reflection angle θ2 in the light guide plate 310-1 impinges on the left end position of the other second diffraction part 410-2-a. A part RL3-1 of the ray of light RL3 incident on the left end position of the other second diffraction part 410-2-a is reflected and diffracted at the left end position and then refracted by the surface, adjacent to the eyeball EB, of the light guide plate 310-1 to impinge on the light concentration position P1 to form the left maximum angle of view, and the other part RL3-2 is totally reflected by the surface, remote from the eyeball EB, of the light guide plate 310-1 and then totally reflected by the surface adjacent to the eyeball EB to impinge on the left end position of the fourth diffraction part 410-1-2. A part RL3-2a of the ray of light RL3-2 incident on the left end position of the fourth diffraction part 410-1-2 is reflected and diffracted at the left end position and then refracted by the surface, adjacent to the eyeball EB, of the light guide plate 310-1 to impinge on the light concentration position P2, and the other part RL3-2b is totally reflected by the surface, remote from the eyeball EB, of the light guide plate 310-1 and then totally reflected by the surface adjacent to the eyeball EB to impinge on the left end position of the other second diffraction part 410-2-b. The ray of light RL3-2b incident on the left end position of the other second diffraction part 410-2-b is reflected and diffracted at the left end position and then refracted by the surface, adjacent to the eyeball EB, of the light guide plate 310-1 to impinge on the light concentration position P3 to form the left maximum angle of view.

As described above, the plurality of rays of light forming the full angle of view of the image I can be concentrated on each of the three light concentration positions P1 to P3, so that even if there is a positional deviation between the eyeball EB and the image display device 10-7, the image can be visually recognized at a wide angle of view with disappearance of the image I minimized.

For example, as illustrated in FIG. 17, in a case where the eyeball EB faces the image display device 10-7, the light concentration position P2 is located over the eyeball EB, so that the image can be displayed at a wide angle of view.

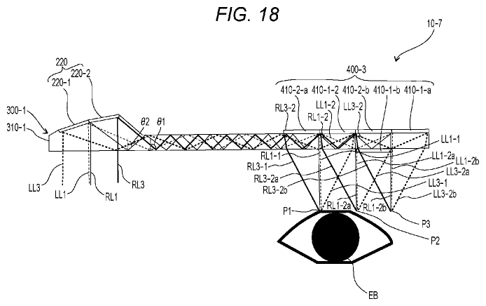

For example, as illustrated in FIG. 18, in a case where the eyeball EB is located on the left side relative to the position where the eyeball EB faces the image display device 10-7, the light concentration position P1 is located over the eyeball EB, so that the image can be displayed at a wide angle of view.

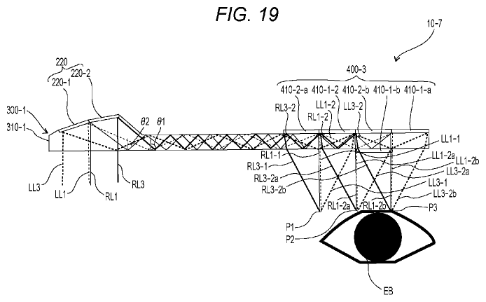

For example, as illustrated in FIG. 19, in a case where the eyeball EB is located on the right side relative to the position where the eyeball EB faces the image display device 10-7, the light concentration position P3 is located over the eyeball EB, so that the image can be displayed at a wide angle of view.

10. <Modification of Present Technology>

The configuration of the display device according to each of the embodiments of the present technology described above may be modified as needed.

(Image Display Device According to First Modification)

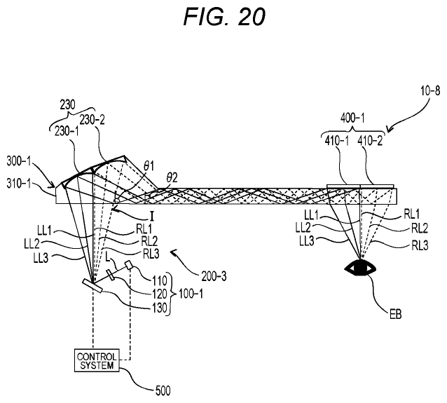

As illustrated in FIG. 20, an image display device 10-8 according to a first modification is similar in configuration to the image display device 10-1 according to the first embodiment except that the configuration of the incident optical system is different.

An incident optical system 200-3 of the image display device 10-8 includes a composite mirror 230 instead of the collimating lens 210 and the composite mirror 220 (see FIG. 1).

The composite mirror 230 is disposed at approximately the same position as the composite mirror 220.

The composite mirror 230 includes first and second concave mirrors 230-1, 230-2.

The plurality of rays of light (for example, LL1 to LL3) forming different angles of view of the angle of view region of the left half of the full angle of view of the image I impinges on the first concave mirror 230-1 and is then converted into approximately parallel rays of light and reflected by the first concave mirror 230-1 to impinge on the surface, adjacent to the eyeball EB, of the light guide plate 310-1 at a predetermined incident angle. The incident angle is an incident angle that causes the plurality of rays of light (for example, LL1 to LL3) to totally reflect at the total reflection angle θ1 in the light guide plate 310-1.

The plurality of rays of light (for example, RL1 to RL3) forming different angles of view of the angle of view region of the right half of the full angle of view of the image I impinges on the second concave mirror 230-2 and is then converted into approximately parallel rays of light and reflected by the second concave mirror 230-2 to impinge on the surface, adjacent to the eyeball EB, of the light guide plate 310-1 at a predetermined incident angle. The incident angle is an incident angle that causes the plurality of rays of light (for example, RL1 to RL3) to totally reflect at the total reflection angle θ2 in the light guide plate 310-1.

According to the image display device 10-8 according to the first modification, the composite mirror 230 functions as both the collimating lens 210 and the composite mirror 220, so that it is possible to reduce the number of components and the size.

(Image Display Device According to Second Modification)

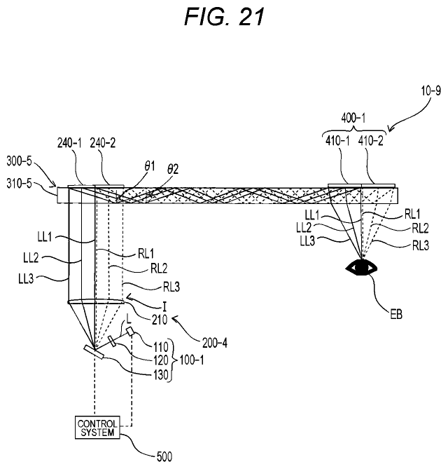

As illustrated in FIG. 21, an image display device 10-9 according to a second modification is similar in configuration to the image display device 10-1 according to the first embodiment except that the configuration of the incident optical system is different.

A light guide plate 310-5 of a light guide system 300-5 of the image display device 10-9 has a flat plate shape as a whole.

An incident optical system 200-4 of the image display device 10-9 includes a plurality of (for example, two) diffraction parts 240-1, 240-2 instead of the composite mirror 220.

For example, the two diffraction parts 240-1, 240-2 are provided adjacent to each other on the surface, remote from the eyeball EB, of the left end of the light guide plate 310-5. The diffraction part 240-1 is located on the left side of the diffraction part 240-2. As an example, each of the two diffraction parts 240-1, 240-2 is a diffraction part of a reflection type.

The diffraction part 240-1 diffracts, in directions approximately parallel to each other, the rays of light (for example, LL1 to LL3) incident in directions approximately parallel to each other. That is, the diffraction part 240-1 has uniform diffraction power from the left end to the right end.

The diffraction part 240-2 diffracts, in directions approximately parallel to each other, the rays of light (for example, RL1 to RL3) incident in directions approximately parallel to each other. That is, the diffraction part 240-2 has uniform diffraction power from the left end to the right end.

The diffraction parts 240-1, 240-2 are different in diffraction power from each other.

More specifically, the diffraction part 240-1 is disposed on the optical path of the plurality of rays of light (for example, LL1 to LL3) that forms the angle of view region of the left half of the image I and passes through the collimating lens 210, and reflects and diffracts the plurality of rays of light to cause the plurality of rays of light to impinge on the surface, adjacent to the eyeball EB, of the light guide plate 310-5 at an incident angle θ1. Each of the plurality of rays of light (for example, LL1 to LL3) incident on the surface adjacent to the eyeball EB at the incident angle θ1 propagates while totally reflecting at the total reflection angle θ1 in the light guide plate 310-5 and is then diffracted by the corresponding first diffraction part 410-1 of the light diffraction system 400-1 to impinge on the eyeball EB.

The diffraction part 240-2 is disposed on the optical path of the plurality of rays of light (for example, RL1 to RL3) that forms the angle of view region of the right half of the image I and passes through the collimating lens 210, and reflects and diffracts the plurality of rays of light to cause the plurality of rays of light to impinge on the surface, adjacent to the eyeball EB, of the light guide plate 310-5 at an incident angle θ2 (<θ1). Each of the plurality of rays of light (for example, RL1 to RL3) incident on the surface adjacent to the eyeball EB at the incident angle θ2 propagates while totally reflecting at the total reflection angle θ2 in the light guide plate 310-5 and is then diffracted by the corresponding second diffraction part 410-2 of the light diffraction system 400-1 to impinge on the eyeball EB.

The image display device 10-9 according to the second modification can produce effects similar to the effects produced by the image display device 10-1 according to the first embodiment and reduce a difference in optical path length between the plurality of rays of light (for example, LL1 to RL3) that forms different angles of view of the image I outside the light guide plate 310-5 as much as possible.

Note that the two diffraction parts 240-1, 240-2 may be each replaced with a diffraction part of a transmission type that transmits and diffracts, in directions approximately parallel to each other, rays of light incident in directions approximately parallel to each other and be provided adjacent to each other on the surface, adjacent to the eyeball EB, of the left end of the light guide plate 310-5.

(Image Display Device According to Third Modification)

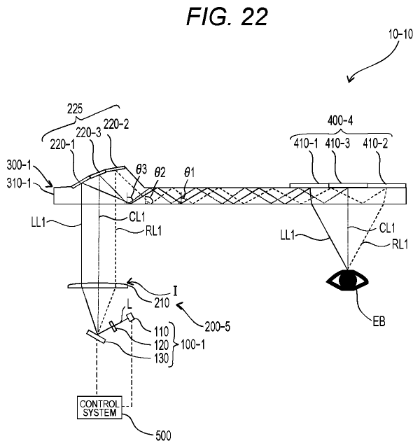

As illustrated in FIG. 22, an image display device 10-10 according to a third modification is similar in configuration to the image display device 10-1 according to the first embodiment except that the configuration of the incident optical system and the configuration of the light diffraction system are different.

In the image display device 10-10, a light diffraction system 400-4 includes first to third diffraction parts 410-1, 410-2, 410-3.

In the image display device 10-10, a composite mirror 225 of an incident optical system 200-5 includes first to third reflectors 220-1, 220-2, 220-3.

The third diffraction part 410-3 is a diffraction part of a reflection type having incident angle selectivity for the incident angle θ3.

In the light diffraction system 400-4, the third diffraction part 410-3 is disposed between the first and second diffraction parts 410-1, 410-2.

In the composite mirror 225, the third reflector 220-3 is disposed between the first and second reflectors 220-1, 220-2.

For example, the ray of light forming each angle of view of the left angle of view region of the full angle of view of the image I (for example, the ray of light LL1 forming the center angle of view of the angle of view region) is reflected by the first reflector 220-1 to propagate while totally reflecting at the total reflection angle θ1 in the light guide plate 310-1 and then reflected and diffracted by the corresponding first diffraction part 410-1 to impinge on the eyeball EB.

For example, the ray of light forming each angle of view of the right angle of view region of the full angle of view of the image I (for example, the ray of light RL1 forming the center angle of view of the angle of view region) is reflected by the second reflector 220-2 to propagate while totally reflecting at the total reflection angle θ2 in the light guide plate 310-1 and then reflected and diffracted by the corresponding second diffraction part 410-2 to impinge on the eyeball EB.

For example, the ray of light forming each angle of view of the center angle of view region of the full angle of view of the image I (for example, the ray of light CL1 forming the center angle of view of the angle of view region) is reflected by the third reflector 220-3 to propagate while totally reflecting at the total reflection angle θ3 in the light guide plate 310-1 and then reflected and diffracted by the corresponding third diffraction part 410-3 to impinge on the eyeball EB.

According to the image display device according to the third modification, the ray of light for each angle of view region obtained by dividing the full angle of view of the image I into three has unique angle information satisfying the condition of total reflection in the light guide plate 310-1, and is diffracted by the diffraction part having selectivity for the unique angle information, so that it is possible to provide a display at a wider angle of view.

(Image Display Device According to Fourth Modification)

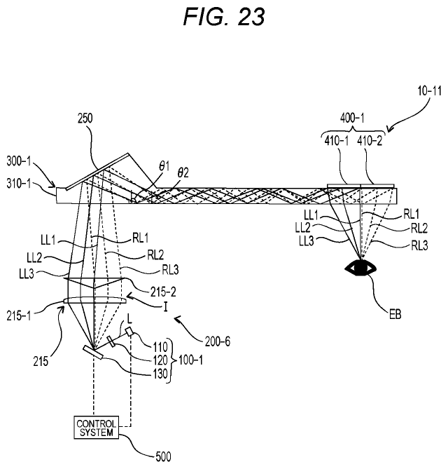

As illustrated in FIG. 23, an image display device 10-11 according to a fourth modification is similar in configuration to the image display device 10-1 according to the first embodiment except that the configuration of the incident optical system is different.

In the image display device 10-11, an incident optical system 200-6 includes an optical system 215 instead of the collimating lens 210, and includes a mirror 250 instead of the composite mirror 220. The mirror 250 is, for example, a plane mirror.

As an example, the optical system 215 includes a collimating lens 215-1 and a triangular prism 215-2.

In the incident optical system 200-6, the collimating lens 215-1 is disposed on an upstream side of the triangular prism 215-2.

The collimating lens 215-1 is disposed so as to make its optical axis orthogonal to the surface, adjacent to the eyeball EB, of the light guide plate 310-1.

As an example, the triangular prism 215-2 is a prism that is approximately isosceles triangular in cross-section and is disposed so as to cause its vertex angle to face the collimating lens 215-1. The center axis of the triangular prism 215-2 approximately coincides with the optical axis of the collimating lens 215-1, for example.

In the image display device 10-11 configured as described above, the plurality of rays of light (for example, LL1 to LL3) forming the angle of view region of the left half of the full angle of view of the image I is converted into approximately parallel rays of light by the left half of the collimating lens 215-1 to impinge on the left half of the triangular prism 215-2. The plurality of rays of light (for example, LL1 to LL3) incident on the left half is refracted in directions parallel to each other by the left half to impinge on the mirror 250. The plurality of rays of light (for example, LL1 to LL3) incident on the mirror 250 is reflected by the mirror 250 to impinge on the surface, adjacent to the eyeball EB, of the light guide plate 310-1 at an incident angle that causes the plurality of rays of light to totally reflect in the light guide plate 310-1 at the total reflection angle θ1. The plurality of rays of light (for example, LL1 to LL3) that has propagated while totally reflecting at the total reflection angle θ1 in the light guide plate 310-1 is reflected and diffracted by the corresponding first diffraction part 410-1 to impinge on the eyeball EB.

The plurality of rays of light (for example, RL1 to RL3) forming the angle of view region of the right half of the full angle of view of the image I is converted into approximately parallel rays of light by the right half of the collimating lens 215-1 to impinge on the right half of the triangular prism 215-2. The plurality of rays of light (for example, RL1 to RL3) incident on the right half is refracted in directions parallel to each other by the right half to impinge on the mirror 250. The plurality of rays of light (for example, RL1 to RL3) incident on the mirror 250 is reflected by the mirror 250 to impinge on the surface, adjacent to the eyeball EB, of the light guide plate 310-1 at an incident angle that causes the plurality of rays of light to totally reflect at the total reflection angle θ2 in the light guide plate 310-1. The plurality of rays of light (for example, RL1 to RL3) that has propagated while totally reflecting at the total reflection angle θ2 in the light guide plate 310-1 is reflected and diffracted by the corresponding second diffraction part 410-2 to impinge on the eyeball EB.

The image display device 10-11 according to the fourth modification can produce effects similar to the effects according to the first embodiment.

(Image Display Device According to Fifth Modification)

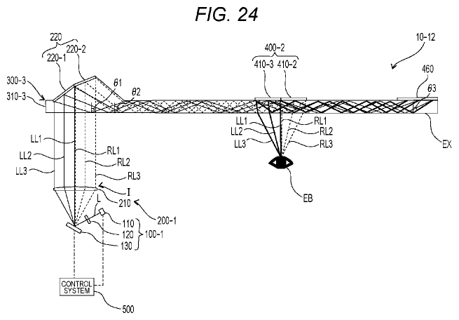

As illustrated in FIG. 24, an image display device 10-12 according to a fifth modification is approximately similar in configuration to the image display device 10-4 (see FIG. 8) according to the fourth embodiment except that the configuration of the light guide system and the configuration of the optical member that folds back an optical path are different.

In the image display device 10-12, no optical member installation part OIP is provided in the extension part EX of a light guide plate 310-3 of a light guide system 300-3, and a diffraction part 460 as the optical member that folds back an optical path is provided, at the right end, on the surface, remote from the eyeball EB, of the light guide plate 310-3, for example. Note that the diffraction part 460 may be provided on the surface, remote from the eyeball EB, of the light guide plate 310-3.

That is, the diffraction part 460 is provided on a side of the light guide plate 310-3 opposite from the position where the plurality of rays of light (for example, LL1 to RL3) impinges on the surface, adjacent to the eyeball EB, of the light guide plate 310-3 relative to the position where the light diffraction system 400-2 is provided.

The diffraction part 460 reflects and diffracts the rays of light incident at the incident angle θ1 to cause the rays of light to impinge on the surface, adjacent to the eyeball EB, of the light guide plate 310-3 at the incident angle that causes the rays of light to totally reflect at the total reflection angle θ3 in the light guide plate 310-3.

The diffraction part 460 is preferably provided at a position where a difference in optical path length between at least two rays of light that each impinge on the light diffraction system 400-2 at a corresponding one of at least two incident angles is smaller, and is more preferably provided at a position where the difference in optical path length is approximately equal to zero.

The plurality of rays of light (for example, RL1 to RL3) forming the right half space region through the collimating lens 210 is reflected by the corresponding second reflector 220-2 to propagate while totally reflecting at the total reflection angle θ2 in the light guide plate 310-3 and then reflected and diffracted toward the eyeball EB by the corresponding diffraction part 410-2.

On the other hand, the plurality of rays of light (for example, LL1 to LL3) forming the left half space region through the collimating lens 210 is reflected by the corresponding first reflector 220-1 to propagate rightward while totally reflecting in the light guide plate 310-3 (totally reflecting even at the position where the light diffraction system 400-2 is provided) and then impinge on the diffraction part 460 provided at the right end of the extension part EX. The plurality of rays of light (for example, LL1 to LL3) incident on the diffraction part 460 has its optical path folded back by the diffraction part 460 (see thick solid lines). More specifically, the plurality of rays of light (for example, LL1 to LL3) incident on the diffraction part 460 is reflected and diffracted by the diffraction part 460 to impinge on the surface, adjacent to the eyeball EB, of the light guide plate 310-3 at the incident angle θ3 that causes the plurality of rays of light to totally reflect at the total reflection angle θ3 in the light guide plate 310-3. The plurality of rays of light (for example, LL1 to LL3) incident on the surface, adjacent to the eyeball EB, of the light guide plate 310-3 after the optical path is folded back propagates while totally reflecting at the total reflection angle θ3 in the light guide plate 310-3 and then reflected and diffracted toward the eyeball EB by the corresponding third diffraction part 410-3.

The image display device 10-12 according to the fifth modification can produce effects similar to the effects produced by the image display device 10-4 according to the fourth embodiment with a simpler and more compact configuration.

(Image Display Device According to Sixth Modification)

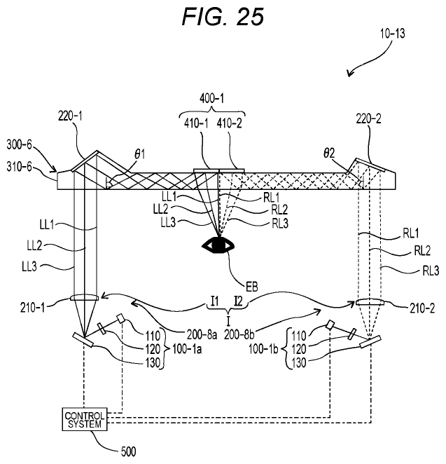

As illustrated in FIG. 25, an image display device 10-13 according to a sixth modification is approximately similar in configuration to the image display device 10-1 (see FIG. 1) according to the first embodiment except that two image formation systems and two incident optical systems are provided.

The image display device 10-13 includes a first image formation system 100-1a that forms an image I1 of the left half of the image I and a second image formation system 100-1b that forms an image 12 of the right half of the image I.

Moreover, the image display device 10-13 includes a first incident optical system 200-8a that causes the plurality of rays of light (for example, LL1 to LL3) forming different angles of view of the image I1 formed by the first image formation system 100-1a to impinge on the vicinity of the left end of the surface, adjacent to the eyeball EB, of the light guide plate 310-6 of the light guide system 300-6, and a second incident optical system 200-8b that causes the plurality of rays of light (for example, RL1 to RL3) forming different angles of view of the image 12 formed by the second image formation system 100-1b to impinge on the vicinity of the right end of the surface, adjacent to the eyeball EB, of the light guide plate 310-6.

The first incident optical system 200-8a includes a collimating lens 210-1 that converts the plurality of rays of light (for example, LL1 to LL3) forming different angles of view of the image I1 formed by the image formation system 100-1a into approximately parallel rays of light, and a mirror 220-1 (for example, a plane mirror) that reflects the plurality of rays of light (for example, LL1 to LL3) converted into approximately parallel rays of light by the collimating lens 210-1 toward the vicinity of the left end of the surface, adjacent to the eyeball EB, of the light guide plate 310-6.

The second incident optical system 200-8b includes a collimating lens 210-2 that converts the plurality of rays of light (for example, RL1 to RL3) forming different angles of view of the image 12 formed by the image formation system 100-1b into approximately parallel rays of light, and a mirror 220-2 (for example, a plane mirror) that reflects the plurality of rays of light (for example, RL1 to RL3) converted into approximately parallel rays of light by the collimating lens 210-2 toward the vicinity of the right end of the surface, adjacent to the eyeball EB, of the light guide plate 310-6.

The light diffraction system 400-1 is provided in the vicinity of the center of the light guide plate 310-6 in the left-right direction.

The plurality of rays of light (for example, LL1 to LL3) forming different angles of view of the image I1 formed by the image formation system 100-1a is converted into approximately parallel rays of light by the collimating lens 210-1 to impinge on the mirror 220-1 through the left end of the surface, adjacent to the eyeball EB, of the light guide plate 310-6. The plurality of rays of light (for example, LL1 to LL3) incident on the mirror 220-1 is reflected by the mirror 220-1 toward the vicinity of the left end of the surface, adjacent to the eyeball EB, of the light guide plate 310-6. The plurality of rays of light (for example, LL1 to LL3) incident on the vicinity of the left end of the surface, adjacent to the eyeball EB, of the light guide plate 310-6 propagates rightward while totally reflecting at the total reflection angle θ1 in the light guide plate 310-6 and is then diffracted toward the eyeball EB by the corresponding first diffraction part 410-1.

The plurality of rays of light (for example, RL1 to RL3) forming different angles of view of the image 12 formed by the image formation system 100-1b is converted into approximately parallel rays of light by the collimating lens 210-2 to impinge on the mirror 220-2 through the right end of the surface, adjacent to the eyeball EB, of the light guide plate 310-6. The plurality of rays of light (for example, RL1 to RL3) incident on the mirror 220-2 is reflected by the mirror 220-2 toward the vicinity of the right end of the surface, adjacent to the eyeball EB, of the light guide plate 310-6. The plurality of rays of light (for example, RL1 to RL3) incident on the vicinity of the right end of the surface, adjacent to the eyeball EB, of the light guide plate 310-6 propagates leftward while totally reflecting at the total reflection angle θ2 in the light guide plate 310-6 and is then diffracted toward the eyeball EB by the corresponding second diffraction part 410-2.

The image display device 10-13 can produce effects similar to the effects according to the first embodiment.

In the image display device 10-13 according to the sixth modification described above, each incident optical system causes the plurality of rays of light to impinge on the light guide plate at the same (single) incident angle, but may cause the plurality of rays of light to impinge on the light guide plate at a plurality of different incident angles. In this case, the light diffraction system may include at least one diffraction part having incident angle selectivity for at least one incident angle of the plurality of incident angles.

(Image Display Device According to Seventh Modification)

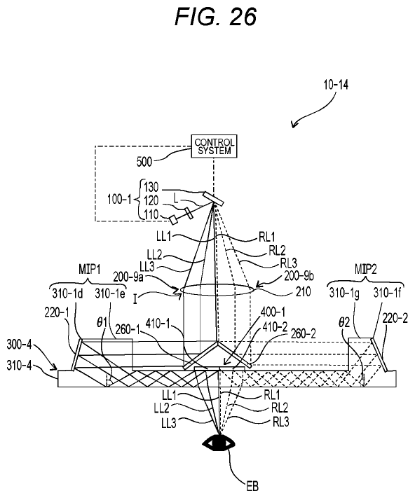

As illustrated in FIG. 26, an image display device 10-14 according to a seventh modification is approximately similar in configuration to the image display device 10-13 (see FIG. 25) according to the sixth modification except that a single image formation system is provided.

The image formation system 100-1 is disposed at a position that is remote from the eyeball EB relative to a light guide plate 310-4 of a light guide system 300-4 and corresponds to the vicinity of the center of the light guide plate 310-4 in the left-right direction.

Furthermore, the image display device 10-14 includes a first incident optical system 200-9a that causes the plurality of rays of light (for example, LL1 to LL3) forming different angles of view of the image I formed by the image formation system 100-1 to impinge on the vicinity of the left end of the surface, adjacent to the eyeball EB, of the light guide plate 310-4, and a second incident optical system 200-9b that causes the plurality of rays of light (for example, RL1 to RL3) forming different angles of view of the image I formed by the image formation system 100-1 to impinge on the vicinity of the right end of the surface, adjacent to the eyeball EB, of the light guide plate 310-4. The first and second incident optical systems 200-9a, 200-9b share the collimating lens 210.

The first incident optical system 200-9a includes the collimating lens 210 that converts the plurality of rays of light (for example, LL1 to LL3) forming different angles of view of the image I formed by the image formation system 100-1 into approximately parallel rays of light, a mirror 260-1 (plane mirror) that reflects the plurality of rays of light (for example, LL1 to LL3) converted into approximately parallel rays of light by the collimating lens 210 leftward, and a mirror 220-1 (plane mirror) that reflects the plurality of rays of light (for example, LL1 to LL3) reflected by the mirror 260-1 toward the vicinity of the left end of the surface, adjacent to the eyeball EB, of the light guide plate 310-4. The mirror 220-1 is installed in a mirror installation part MIP1 provided in the vicinity of the left end of the light guide plate 310-4. The mirror installation part MIP1 includes, in the vicinity of the left end of the light guide plate 310-4, a stepped part 310-1e protruding toward a side remote from the eyeball EB relative to a flat plate part of the light guide plate 310-4, and an opening 310-1d formed at the left end of the stepped part 310-1e. The mirror 220-1 is provided around the opening 310-1d so as to close the opening 310-1d. A right side surface of the stepped part 310-1e is perpendicular to the flat plate part of the light guide plate 310-4.

The second incident optical system 200-9b includes the collimating lens 210 that converts the plurality of rays of light (for example, RL1 to RL3) forming different angles of view of the image I formed by the image formation system 100-1 into approximately parallel rays of light, a mirror 260-2 (plane mirror) that reflects the plurality of rays of light (for example, RL1 to RL3) converted into approximately parallel rays of light by the collimating lens 210 rightward, and a mirror 220-2 (plane mirror) that reflects the plurality of rays of light (for example, RL1 to RL3) reflected by the mirror 260-2 toward the vicinity of the right end of the surface, adjacent to the eyeball EB, of the light guide plate 310-4. The mirror 220-2 is installed in a mirror installation part MIP2 provided in the vicinity of the right end of the light guide plate 310-4. The mirror installation part MIP2 includes, in the vicinity of the right end of the light guide plate 310-4, a stepped part 310-1g protruding toward a side remote from the eyeball EB relative to the flat plate part of the light guide plate 310-4, and an opening 310-1f formed at the right end of the stepped part 310-1g. The mirror 220-2 is provided around the opening 310-1f so as to close the opening 310-1f. A left side surface of the stepped part 310-1g is perpendicular to the flat plate part of the light guide plate 310-4.

The light diffraction system 400-1 is provided in the vicinity of the center of the light guide plate 310-4 in the left-right direction.

The plurality of rays of light (for example, LL1 to LL3) forming different angles of view of the image I formed by the image formation system 100-1 is converted into approximately parallel rays of light by the collimating lens 210 to impinge on the mirror 260-1. The plurality of rays of light (for example, LL1 to LL3) reflected by the mirror 260-1 travels leftward along the flat plate part of the light guide plate 310-4 to enter the stepped part 310-1e through the right side surface of the stepped part 310-1e, and travels leftward in the stepped part 310-1e to impinge on the mirror 220-1. The plurality of rays of light (for example, LL1 to LL3) incident on the mirror 220-1 is reflected by the mirror 220-1 toward the vicinity of the left end of the surface, adjacent to the eyeball EB, of the light guide plate 310-4. The plurality of rays of light (for example, LL1 to LL3) incident on the vicinity of the left end of the surface, adjacent to the eyeball EB, of the light guide plate 310-4 propagates rightward while totally reflecting at the total reflection angle θ1 in the light guide plate 310-4 and is then diffracted toward the eyeball EB by the corresponding first diffraction part 410-1.

The plurality of rays of light (for example, RL1 to RL3) forming different angles of view of the image I formed by the image formation system 100-1 is converted into approximately parallel rays of light by the collimating lens 210 to impinge on the mirror 260-2. The plurality of rays of light (for example, RL1 to RL3) reflected by the mirror 260-2 travels rightward along the flat plate part of the light guide plate 310-4 to enter the stepped part 310-1g through the left side surface of the stepped part 310-1g, and travels rightward in the stepped part 310-1g to impinge on the mirror 220-2. The plurality of rays of light (for example, RL1 to RL3) incident on the mirror 220-2 is reflected by the mirror 220-2 toward the vicinity of the right end of the surface, adjacent to the eyeball EB, of the light guide plate 310-4. The plurality of rays of light (for example, RL1 to RL3) incident on the vicinity of the right end of the surface, adjacent to the eyeball EB, of the light guide plate 310-4 propagates leftward while totally reflecting at the total reflection angle θ2 in the light guide plate 310-4 and is then diffracted toward the eyeball EB by the corresponding second diffraction part 410-2.

The image display device 10-14 can produce effects similar to the effects according to the first embodiment.

In the image display device 10-14 according to the seventh modification described above, each incident optical system causes the plurality of rays of light to impinge on the light guide plate at the same (single) incident angle, but may cause the plurality of rays of light to impinge on the light guide plate at a plurality of different incident angles. In this case, the light diffraction system may include at least one diffraction part having incident angle selectivity for at least one incident angle of the plurality of incident angles.

(Image Display Device According to Eighth Modification)

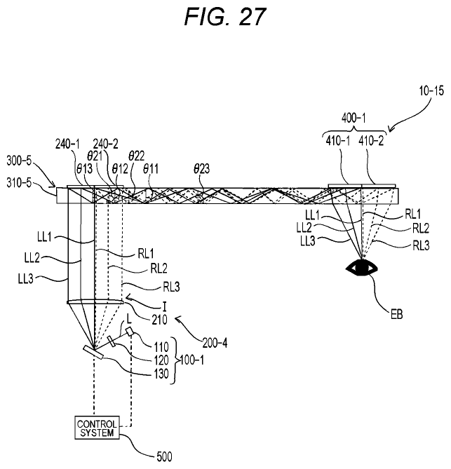

As illustrated in FIG. 27, an image display device 10-15 according to an eighth modification is approximately similar in configuration to the image display device 10-9 (see FIG. 21) according to the second modification.

In the image display device 10-15 according to the eighth modification, the diffraction part 240-1 of the incident optical system 200-4 diffracts, in directions non-parallel to each other, the rays of light (for example, LL1 to LL3) incident in directions parallel to each other. More specifically, as an example, the diffraction part 240-1 has a diffraction power distribution in which the diffraction power monotonously decreases from the left end to the right end.

For example, the diffraction part 240-1 reflects and diffracts the incident ray of light LL1 in a direction that causes the ray of light LL1 to impinge on the surface, adjacent to the eyeball EB, of the light guide plate 310-5 at an incident angle θ11.

For example, the diffraction part 240-1 reflects and diffracts the incident ray of light LL2 in a direction that causes the ray of light LL2 to impinge on the surface, adjacent to the eyeball EB, of the light guide plate 310-5 at an incident angle θ12 (<θ11).

For example, the diffraction part 240-1 reflects and diffracts the incident ray of light LL3 in a direction that causes the ray of light LL3 to impinge on the surface, adjacent to the eyeball EB, of the light guide plate 310-5 at an incident angle θ13 (<θ12).

In the image display device 10-15 according to the eighth modification, the diffraction part 240-2 of the incident optical system 200-4 diffracts, in directions non-parallel to each other, the rays of light (for example, RL1 to RL3) incident in directions parallel to each other. More specifically, as an example, the diffraction part 240-2 has a diffraction power distribution in which the diffraction power monotonously decreases from the left end to the right end.

For example, the diffraction part 240-2 reflects and diffracts the incident ray of light RL1 in a direction that causes the ray of light RL1 to impinge on the surface, adjacent to the eyeball EB, of the light guide plate 310-5 at an incident angle θ21.

For example, the diffraction part 240-2 reflects and diffracts the incident ray of light RL2 in a direction that causes the ray of light RL2 to impinge on the surface, adjacent to the eyeball EB, of the light guide plate 310-5 at an incident angle θ22 (>θ21).

For example, the diffraction part 240-2 reflects and diffracts the incident ray of light RL3 in a direction that causes the ray of light RL3 to impinge on the surface, adjacent to the eyeball EB, of the light guide plate 310-5 at an incident angle θ23 (>θ22).

As an example, the first diffraction part 410-1 of the light diffraction system 400-1 has incident angle selectivity for an incident angle range 1 (for example, θ13 to θ11) including the incident angles θ11, θ12, θ13 (θ11 >θ12 >θ13). As an example, the first diffraction part 410-1 has a diffraction power distribution in which the diffraction power monotonically increases from the left end to the right end.

As an example, the second diffraction part 410-2 of the light diffraction system 400-1 has incident angle selectivity for an incident angle range 2 (for example, θ21 to θ23) including the incident angles θ21, θ22, θ23 (θ21<θ22<θ23). As an example, the second diffraction part 410-2 has a diffraction power distribution in which the diffraction power monotonically decreases from the left end to the right end.

The incident angle range 1 and the incident angle range 2 do not overlap each other (for example, θ13 >θ23).

For example, the ray of light LL1 incident on the diffraction part 240-1 is reflected and diffracted by the diffraction part 240-1 to impinge on the surface, adjacent to the eyeball EB, of the light guide plate 310-5 at the incident angle θ11. The ray of light LL1 incident on the surface, adjacent to the eyeball EB, of the light guide plate 310-5 at the incident angle θ11 propagates while totally reflecting at the total reflection angle θ11 in the light guide plate 310-5 and is then reflected and diffracted by the corresponding first diffraction part 410-1 of the light diffraction system 400-1 to impinge on the eyeball EB.

For example, the ray of light LL2 incident on the diffraction part 240-1 is reflected and diffracted by the diffraction part 240-1 to impinge on the surface, adjacent to the eyeball EB, of the light guide plate 310-5 at the incident angle θ12. The ray of light LL2 incident on the surface, adjacent to the eyeball EB, of the light guide plate 310-5 at the incident angle θ12 propagates while totally reflecting at the total reflection angle θ12 in the light guide plate 310-5 and is then reflected and diffracted by the corresponding first diffraction part 410-1 of the light diffraction system 400-1 to impinge on the eyeball EB.

For example, the ray of light LL3 incident on the diffraction part 240-1 is reflected and diffracted by the diffraction part 240-1 to impinge on the surface, adjacent to the eyeball EB, of the light guide plate 310-5 at the incident angle θ13. The ray of light LL3 incident on the surface, adjacent to the eyeball EB, of the light guide plate 310-5 at the incident angle θ13 propagates while totally reflecting at the total reflection angle θ13 in the light guide plate 310-5 and is then reflected and diffracted by the corresponding first diffraction part 410-1 of the light diffraction system 400-1 to impinge on the eyeball EB.

For example, the ray of light RL1 incident on the diffraction part 240-2 is reflected and diffracted by the diffraction part 240-2 to impinge on the surface, adjacent to the eyeball EB, of the light guide plate 310-5 at the incident angle θ21. The ray of light RL1 incident on the surface, adjacent to the eyeball EB, of the light guide plate 310-5 at the incident angle θ21 propagates while totally reflecting at the total reflection angle θ21 in the light guide plate 310-5 (totally reflecting even at the position of the first diffraction part 410-1 that is not a corresponding diffraction part of the light diffraction system 400-1) and is then diffracted by the corresponding second diffraction part 410-2 of the light diffraction system 400-1 to impinge on the eyeball EB.

For example, the ray of light RL2 incident on the diffraction part 240-2 is reflected and diffracted by the diffraction part 240-2 to impinge on the surface, adjacent to the eyeball EB, of the light guide plate 310-5 at the incident angle θ22. The ray of light RL2 incident on the surface, adjacent to the eyeball EB, of the light guide plate 310-5 at the incident angle θ22 propagates while totally reflecting at the total reflection angle θ22 in the light guide plate 310-5 (totally reflecting even at the position of the first diffraction part 410-1 that is not a corresponding diffraction part of the light diffraction system 400-1) and is then diffracted by the corresponding second diffraction part 410-2 of the light diffraction system 400-1 to impinge on the eyeball EB.

For example, the ray of light RL3 incident on the diffraction part 240-2 is reflected and diffracted by the diffraction part 240-2 to impinge on the surface, adjacent to the eyeball EB, of the light guide plate 310-5 at the incident angle θ23. The ray of light RL3 incident on the surface, adjacent to the eyeball EB, of the light guide plate 310-5 at the incident angle θ23 propagates while totally reflecting at the total reflection angle θ23 in the light guide plate 310-5 (totally reflecting even at the position of the first diffraction part 410-1 that is not a corresponding diffraction part of the light diffraction system 400-1) and is then diffracted by the corresponding second diffraction part 410-2 of the light diffraction system 400-1 to impinge on the eyeball EB.

The image display device 10-15 according to the eighth modification produces effects similar to the effects produced by the image display device 10-9 according to the second modification.

Note that the two diffraction parts 240-1, 240-2 may be each replaced with a diffraction part of a transmission type that transmits and diffracts, in directions non-parallel to each other, rays of light incident in directions parallel to each other and be provided adjacent to each other on the surface, adjacent to the eyeball EB, of the left end of the light guide plate 310-5.

In each of the above-described embodiments and modifications, the image formation system forms an image by deflecting rays of light from the laser light source, or alternatively, may use a light source (for example, a light emitting diode, an organic EL element, or the like) and a liquid crystal panel.

It is a light emitting diode (LED), an organic EL element, or the like.

For example, in each of the above-described embodiments and modifications, the light guide system need not include the light guide plate. For example, the light guide system may include at least one mirror.

For example, the number of diffraction parts included in the light diffraction system is not limited to any of the numbers according to the above-described embodiments and modifications, and may be changed as needed in accordance with the number of angle of view regions obtained by dividing the full angle of view, the number of space regions, and the number of incident angles. In this case, the plurality of diffraction parts may include at least one diffraction part in which a plurality of diffraction structures is laminated and/or diffraction part in which a plurality of diffraction patterns is formed.

The diffraction part of a reflection type used in each of the above-described embodiments and modifications may be a diffraction part of a transmission type.

Note that, in a case where the diffraction part of a transmission type is used, it is necessary to provide the diffraction part of a transmission type on the surface, adjacent to the eyeball EB, of the light guide plate.

The diffraction part of a transmission type can transmit outside light, so that the diffraction part of a transmission type is effective for use in a state where outside light does not enter (for example, in a case where an image display device displays a VR image and the like).

In each of the above-described embodiments and modifications, the mirror of the incident optical system is provided as a separate member in the opening of the light guide plate, but is not limited to such a configuration, and may be, for example, a reflection film provided on an inner wall surface or an outer wall surface of the light guide plate. In this case, it is not necessary to provide an opening in the light guide plate, but it is necessary to process a part of the light guide plate into a mirror shape.

The configurations according to the above-described embodiments and modifications may be combined with each other within a range where there is no contradiction.

Furthermore, the present technology may have the following configurations.

(1)

An image display device including:
an image formation system configured to form an image from light;
a light guide system;
an incident optical system configured to cause a plurality of rays of light forming different angles of view of the image to impinge on the light guide system; and
a light diffraction system configured to diffract the plurality of rays of light guided by the light guide system to cause the plurality of rays of light to impinge on an eyeball in different directions, in which
the light diffraction system has incident angle selectivity for at least one of incident angles at which the plurality of rays of light guided by the light guide system impinges on the light diffraction system.

(2)

The image display device according to (1), in which at least two of the incident angles of the plurality of rays of light are different from each other.

(3)

The image display device according to (2), in which the light diffraction system includes a plurality of diffraction parts having incident angle selectivity for at least one of the at least two incident angles.

(4)

The image display device according to (3), in which at least two of the plurality of diffraction parts have incident angle selectivity for different incident angles of the at least two incident angles.

(5)

The image display device according to (3) or (4), in which at least two of the plurality of diffraction parts have incident angle selectivity for an identical incident angle of the at least two incident angles.

(6)

The image display device according to any one of (3) to (5), in which the light guide system includes a light guide plate, and at least two rays of light that each impinge on the light diffraction system at a corresponding one of the at least two incident angles are at least two rays of light that have propagated while totally reflecting at mutually different total reflection angles in the light guide plate.

(7)

The image display device according to (6), in which the at least two rays of light that each impinge on the light diffraction system at a corresponding one of the at least two incident angles are at least two rays of light that have caused to impinge on the light guide plate at mutually different incident angles by the incident optical system.

(8)

The image display device according to (7), in which the incident optical system converts the plurality of rays of light forming different angles of view of the image into approximately parallel rays of light and causes the plurality of rays of light to impinge on the light guide plate.

(9)

The image display device according to any one of (6) to (8), in which each of the plurality of diffraction parts is provided at a position that coincides with a common multiple of a propagation distance in the light guide plate of a corresponding one of the at least two rays of light that each impinge on the light diffraction system at a corresponding one of the at least two incident angles.

(10)

The image display device according to (9), in which the common multiple is a least common multiple.

(11)

The image display device according to any one of (6) to (10), in which ½ of a total reflection cycle of a ray of light having a longest total reflection cycle of the at least two rays of light that each impinge on the light diffraction system at a corresponding one of the at least two incident angles coincides with an integral multiple of a total reflection cycle of a ray of light other than the ray of light having the longest total reflection cycle of the at least two rays of light.

(12)

The image display device according to (6) to (10), in which each of the plurality of diffraction parts is provided at at least a position where a ray of light that impinges on the light diffraction system at a corresponding one of the incident angles impinges on a surface, adjacent to the eyeball, of the light guide plate or at at least a position where a ray of light that impinges on the light diffraction system at a corresponding one of the incident angles impinges on a surface, remote from the eyeball, of the light guide plate.

(13)

The image display device according to any one of (1) to (12), in which the light diffraction system diffracts a part of each of the plurality of rays of light guided by the light guide system toward a plurality of different positions adjacent to the eyeball.

(14)

The image display device according to any one of (3) to (12), in which the light diffraction system includes a diffraction part group including at least two of the diffraction parts that sequentially diffract different parts of each of at least two rays of light that each impinge on the light diffraction system at a corresponding one of the at least two incident angles toward a plurality of different positions adjacent to the eyeball.

(15)

The image display device according to any one of (3) to (12) or (14), in which the plurality of diffraction parts includes the diffraction part having at least two diffraction structures laminated in a thickness direction of the light guide plate, and the at least two diffraction structures each have incident angle selectivity for the at least two incident angles.

(16)

The image display device according to any one of (3) to (12), (14), or (15), in which the plurality of diffraction parts includes the diffraction part in which at least two diffraction patterns are provided, and the at least two diffraction patterns each have incident angle selectivity for the at least two incident angles.

(17)

The image display device according to any one of (2) to (12) or (14) to (16), in which at least two rays of light that each impinge on the light diffraction system at a corresponding one of the at least two incident angles are identical in wavelength to each other.

(18)

The image display device according to any one of (1) to (17), in which the image formation system further includes a chromatic aberration correction diffraction part configured to correct chromatic aberration in the light diffraction system.

(19)

The image display device according to any one of (6) to (12), in which the incident optical system includes a correction member configured to correct a difference in optical path length between the at least two rays of light that each impinge on the light diffraction system at a corresponding one of the at least two incident angles, the optical path length being from a position of incidence on the light guide plate to a corresponding one of the diffraction parts.

(20)

The image display device according to any one of (6) to (12), or (19), further including an optical member provided on a side of the light guide plate opposite from a position where the plurality of rays of light impinges on the light guide plate relative to a position where the light diffraction system is provided, in which, of the at least two rays of light that each impinge on the light diffraction system at a corresponding one of the at least two incident angles, a ray of light other than a ray of light having a longest optical path length from the position of incidence on the light guide plate to a corresponding one of the diffraction parts is diffracted by the corresponding one of the diffraction parts after an optical path is folded back by the optical member.

(21)

The image display device according to (20), in which the optical member is disposed at a position where the difference in optical path length between the at least two rays of light that each impinge on the light diffraction system at a corresponding one of the at least two incident angles is smaller.

(22)

The image display device according to any one of (1) to (21), in which the image formation system includes a light source, a light deflector configured to deflect a ray of light emitted from the light source, an optical element disposed on an optical path between the light source and the light deflector, and a drive unit capable of moving the optical element in an optical axis direction of the optical element.

(23)

The image display device according to (22), further including a line-of-sight detection system configured to detect a line-of-sight that is an orientation of the eyeball, and a control system configured to control the drive unit on the basis of a detection result of the line-of-sight detection system and/or an image display position.

(24)

The image display device according to (22), further including a control system configured to control the drive unit on the basis of an image display position.

(25)

The image display device according to any one of (1) to (24), further including a drive system capable of changing a position and/or an orientation of the image formation system.

(26)

The image display device according to (25), further including a line-of-sight detection system configured to detect a line-of-sight that is an orientation of the eyeball, and a control system configured to control the drive system on the basis of a detection result of the line-of-sight detection system and/or an image display position.

(27)

The image display device according to (25), further including a control system configured to control the drive system on the basis of an image display position.

(28)

The image display device according to (7), in which the incident optical system includes a collimating lens configured to convert the plurality of rays of light forming different angles of view of the image into approximately parallel rays of light, and a mirror configured to reflect the plurality of rays of light converted into approximately parallel rays of light by the collimating lens in different directions for each space region to cause the plurality of rays of light to impinge on the light guide plate at different incident angles.

(29)

The image display device according to (7), in which the incident optical system includes a mirror, and an optical system configured to cause the plurality of rays of light forming different angles of view of the image to impinge on the mirror at different angles for each angle of view region, and the mirror reflects the plurality of incident rays of light toward the light guide plate.

(30)

An image display method including:
forming an image from light;
causing a plurality of rays of light forming different angles of view of the image to impinge on a light guide system;
guiding, by the light guide system, the plurality of rays of light; and
causing the plurality of rays of light guided in the guiding to impinge on an eyeball in different directions by diffracting, by a light diffraction system, the plurality of rays of light, in which
the light diffraction system has incident angle selectivity for at least one of incident angles at which the plurality of rays of light guided by the light guide system impinges on the light diffraction system.

(31)

The image display method according to (30), in which at least two of the incident angles of the plurality of rays of light are different from each other.

(32)

The image display method according to (31), in which the light diffraction system has incident angle selectivity for at least one incident angle of the at least two incident angles, and in the causing the plurality of rays of light to impinge, a ray of light incident on the light diffraction system at the at least one incident angle of the plurality of rays of light is selectively diffracted by the light diffraction system.

### REFERENCE SIGNS LIST

10 (10-1 to 10-15) Image display device
100-1, 100-2, 100-6 Image formation system
110 Light source
120 Optical element
130 Light deflector
150 Drive unit
200-1, 200-2, 200-3, 200-4, 200-5, 200-6 Incident optical system
210 Collimating lens
213 Correction member
215 Optical system
220, 225 Composite mirror (mirror)
250 Mirror
300-1, 300-2, 300-3, 300-4, 300-5, 300-6 Light guide system
310-1, 310-2, 310-3, 310-4, 310-5, 310-6 Light guide plate
400-1, 400-2, 400-3 Light diffraction system
410-1 First diffraction part (diffraction part)
410-2 Second diffraction part (diffraction part)
410-3 Third diffraction part (diffraction part)
410-1-2 Fourth diffraction part (diffraction part)
450 Optical member
460 Diffraction part (optical member)
500 Control system
600 Drive system
700 Line-of-sight detection system
I Image
θ1, θ2, θ3 Total reflection angle
EB Eyeball
L Light

1. An image display device comprising:
light;
an image formation system configured to form an image from a light guide system;
an incident optical system configured to cause a plurality of rays of light forming different angles of view of the image to impinge on the light guide system; and
a light diffraction system configured to diffract the plurality of rays of light guided by the light guide system to cause the plurality of rays of light to impinge on an eyeball in different directions, wherein
the light diffraction system has incident angle selectivity for at least one of incident angles at which the plurality of rays of light guided by the light guide system impinges on the light diffraction system.

2. The image display device according to claim 1, wherein at least two of the incident angles of the plurality of rays of light are different from each other.

3. The image display device according to claim 2, wherein the light diffraction system includes a plurality of diffraction parts having incident angle selectivity for at least one of the at least two incident angles.

4. The image display device according to claim 3, wherein at least two of the plurality of diffraction parts have incident angle selectivity for different incident angles of the at least two incident angles.

5. The image display device according to claim 3, wherein at least two of the plurality of diffraction parts have incident angle selectivity for an identical incident angle of the at least two incident angles.

6. The image display device according to claim 3, wherein
the light guide system includes a light guide plate, and
at least two rays of light that each impinge on the light diffraction system at a corresponding one of the at least two incident angles are at least two rays of light that have propagated while totally reflecting at mutually different total reflection angles in the light guide plate.

7. The image display device according to claim 6, wherein the at least two rays of light that each impinge on the light diffraction system at a corresponding one of the at least two incident angles are at least two rays of light that have caused to impinge on the light guide plate at mutually different incident angles by the incident optical system.

8. The image display device according to claim 7, wherein the incident optical system converts the plurality of rays of light forming different angles of view of the image into approximately parallel rays of light and causes the plurality of rays of light to impinge on the light guide plate.

9. The image display device according to claim 6, wherein each of the plurality of diffraction parts is provided at a position that coincides with a common multiple of a propagation distance in the light guide plate of a corresponding one of the at least two rays of light that each impinge on the light diffraction system at a corresponding one of the at least two incident angles.

10. The image display device according to claim 9, wherein the common multiple is a least common multiple.

11. The image display device according to claim 6, wherein ½ of a total reflection cycle of a ray of light having a longest total reflection cycle of the at least two rays of light that each impinge on the light diffraction system at a corresponding one of the at least two incident angles coincides with an integral multiple of a total reflection cycle of a ray of light other than the ray of light having the longest total reflection cycle of the at least two rays of light.

12. The image display device according to claim 6, wherein each of the plurality of diffraction parts is provided at at least a position where a ray of light that impinges on the light diffraction system at a corresponding one of the incident angles impinges on a surface, adjacent to the eyeball, of the light guide plate or at at least a position where a ray of light that impinges on the light diffraction system at a corresponding one of the incident angles impinges on a surface, remote from the eyeball, of the light guide plate.

13. The image display device according to claim 1, wherein the light diffraction system diffracts a part of each of the plurality of rays of light guided by the light guide system toward a plurality of different positions adjacent to the eyeball.

14. The image display device according to claim 3, wherein the light diffraction system includes a diffraction part group including at least two of the diffraction parts that sequentially diffract different parts of each of at least two rays of light that each impinge on the light diffraction system at a corresponding one of the at least two incident angles toward a plurality of different positions adjacent to the eyeball.

15. The image display device according to claim 3, wherein
the plurality of diffraction parts includes the diffraction part having at least two diffraction structures laminated in a thickness direction of the light guide plate, and
the at least two diffraction structures each have incident angle selectivity for the at least two incident angles.

16. The image display device according to claim 3, wherein
the plurality of diffraction parts includes the diffraction part in which at least two diffraction patterns are provided, and
the at least two diffraction patterns each have incident angle selectivity for the at least two incident angles.

17. The image display device according to claim 2, wherein at least two rays of light that each impinge on the light diffraction system at a corresponding one of the at least two incident angles are identical in wavelength to each other.

18. The image display device according to claim 1, wherein the image formation system further includes a chromatic aberration correction diffraction part configured to correct chromatic aberration in the light diffraction system.

19. The image display device according to claim 6, wherein the incident optical system includes a correction member configured to correct a difference in optical path length between the at least two rays of light that each impinge on the light diffraction system at a corresponding one of the at least two incident angles, the optical path length being from a position of incidence on the light guide plate to a corresponding one of the diffraction parts.

20. The image display device according to claim 6, further comprising an optical member provided on a side of the light guide plate opposite from a position where the plurality of rays of light impinges on the light guide plate relative to a position where the light diffraction system is provided, wherein
of the at least two rays of light that each impinge on the light diffraction system at a corresponding one of the at least two incident angles, a ray of light other than a ray of light having a longest optical path length from the position of incidence on the light guide plate to a corresponding one of the diffraction parts is diffracted by the corresponding one of the diffraction parts after an optical path is folded back by the optical member.

21. The image display device according to claim 20, wherein the optical member is disposed at a position where the difference in optical path length between the at least two rays of light that each impinge on the light diffraction system at a corresponding one of the at least two incident angles is smaller.

22. The image display device according to claim 1, wherein
the image formation system includes:
a light source;
a light deflector configured to deflect a ray of light emitted from the light source;
an optical element disposed on an optical path between the light source and the light deflector; and
a drive unit capable of moving the optical element in an optical axis direction of the optical element.

23. The image display device according to claim 22, further comprising:
a line-of-sight detection system configured to detect a line-of-sight that is an orientation of the eyeball; and
a control system configured to control the drive unit on a basis of a detection result of the line-of-sight detection system and/or an image display position.

24. The image display device according to claim 22, further comprising a control system configured to control the drive unit on a basis of an image display position.

25. The image display device according to claim 1,
further comprising a drive system capable of changing a position and/or an orientation of the image formation system.

26. The image display device according to claim 25, further comprising:
a line-of-sight detection system configured to detect a line-of-sight that is an orientation of the eyeball; and
a control system configured to control the drive system on a basis of a detection result of the line-of-sight detection system and/or an image display position.

27. The image display device according to claim 25, further comprising a control system configured to control the drive system on a basis of an image display position.

28. The image display device according to claim 7, wherein
the incident optical system includes:
a collimating lens configured to convert the plurality of rays of light forming different angles of view of the image into approximately parallel rays of light; and
a mirror configured to reflect the plurality of rays of light converted into approximately parallel rays of light by the collimating lens in different directions for each space region to cause the plurality of rays of light to impinge on the light guide plate at different incident angles.

29. The image display device according to claim 7, wherein
the incident optical system includes:
a mirror; and
an optical system configured to cause the plurality of rays of light forming different angles of view of the image to impinge on the mirror at different angles for each angle of view region, and
the mirror reflects the plurality of incident rays of light toward the light guide plate.

30. An image display method comprising:
forming an image from light;
causing a plurality of rays of light forming different angles of view of the image to impinge on a light guide system;
guiding, by the light guide system, the plurality of rays of light; and
causing the plurality of rays of light guided in the guiding to impinge on an eyeball in different directions by diffracting, by a light diffraction system, the plurality of rays of light, wherein
the light diffraction system has incident angle selectivity for at least one of incident angles at which the plurality of rays of light guided by the light guide system impinges on the light diffraction system.

31. The image display method according to claim 30, wherein at least two of the incident angles of the plurality of rays of light are different from each other.

32. The image display method according to claim 31, wherein
the light diffraction system has incident angle selectivity for at least one incident angle of the at least two incident angles, and
in the causing the plurality of rays of light to impinge, a ray of light incident on the light diffraction system at the at least one incident angle of the plurality of rays of light is selectively diffracted by the light diffraction system.
